(19) United States
(12) Patent Application Publication
(10) Pub. No.: US 2026/0253125 A1
(43) Pub. Date: Aug. 27, 2026

(54) SYSTEM

(71) Applicant: SoftBank Group Corp., Tokyo (JP)

(72) Inventor: Shota SUZUKI, Tokyo (JP)

(73) Assignee: SoftBank Group Corp., Tokyo (JP)

(21) Appl. No.: 19/536,249

(22) Filed: Feb. 11, 2026

(30) Foreign Application Priority Data
Feb. 21, 2025 (JP) 2025-027018

(51) Int. Cl. G06Q 30/0601; G06F 40/30; G06Q 10/40

(52) U.S. Cl. CPC G06Q 30/06311; G06F 40/30; G06Q 10/40

(57) ABSTRACT

The system according to the embodiment comprises a collection unit, an analysis unit, and a selection unit. The collection unit collects talk histories. The analysis unit analyzes the collected talk histories. The selection unit selects a present based on an analysis result obtained by the analysis unit.

### CROSS-REFERENCE TO RELATED APPLICATION

The present application claims priority to and incorporates by reference the entire contents of Japanese Patent Application No. 2025-027018 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to grasp the preferences of the other party and select an optimal present.

### SUMMARY OF THE INVENTION

The system according to the embodiment comprises a collection unit, an analysis unit, and a selection unit. The collection unit collects talk histories. The analysis unit analyzes the collected talk histories. The selection unit selects a present based on an analysis result obtained by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

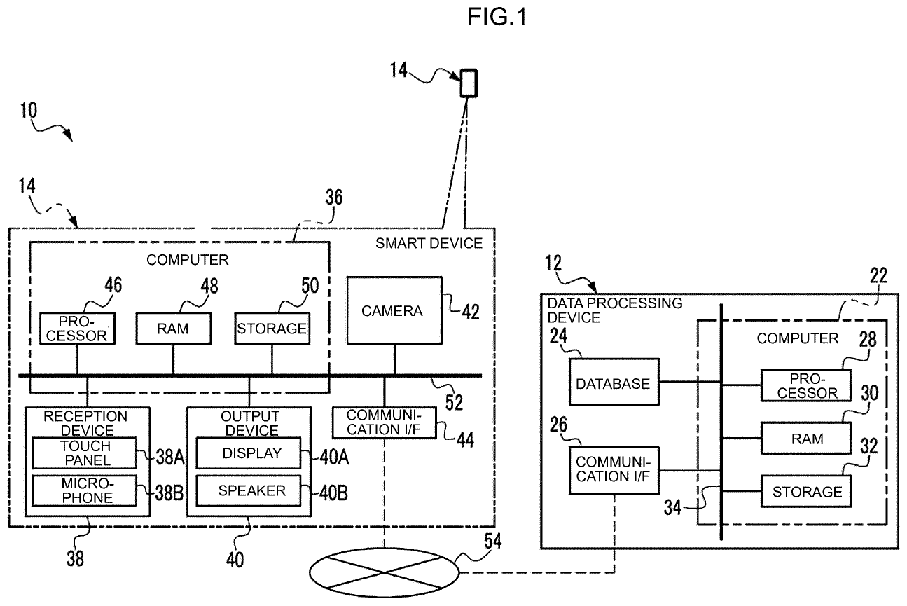

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

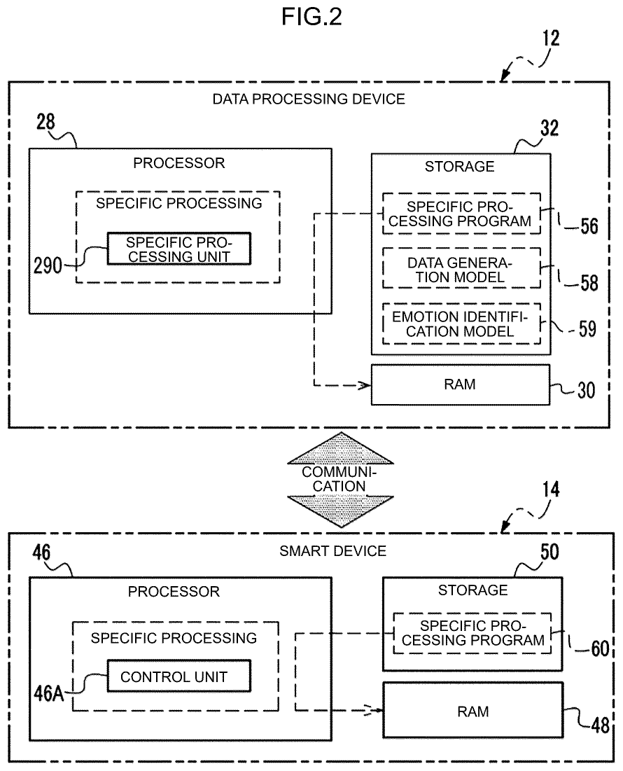

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The present invention's present selection system according to the embodiment is a system that analyzes talk histories of communication applications to understand the preferences of family members, partners, and friends, and selects the optimal present for each individual. In this present selection system, the user provides the talk history from a communication application, and AI analyzes the talk history to identify the preferences and interests of the other party. For example, information about hobbies or desired items that the other party frequently discusses is extracted. Subsequently, the AI proposes the optimal present based on the identified preferences and interests. As a result, the user can understand the other party's preferences and select the optimal present. Even those who are not good at choosing presents can fully express their daily gratitude or special feelings, turning gifts for loved ones into special memories. For example, the present selection system allows the user to provide the talk history from a communication application to the AI. Next, the AI analyzes the talk history and identifies the preferences and interests of the other party. For instance, information about hobbies or desired items that the other party frequently discusses is extracted. Then, the AI proposes the optimal present based on the identified preferences and interests. This enables the user to understand the other party's preferences and select the optimal present. Even those who are not good at choosing presents can fully express their daily gratitude or special feelings, turning gifts for loved ones into special memories. Thus, the present selection system enables the user to select the optimal present for the other party. Specifically, the present selection system accepts as input talk history data exported from the user's communication application (e.g., arrays of text messages in JSON format, audio waveform data of voice messages, binary data of image files, etc.). First, in the preprocessing unit, text data is normalized (e.g., removal of emojis and stamps, unification of line breaks and special symbols), audio data is converted to text via speech recognition, and image data features are extracted (e.g., object recognition using CNN). Next, the analysis unit uses a natural language processing model (e.g., Transformer-based large language model) to extract feature vectors from the talk history (e.g., topic distribution vectors, emotion score vectors, lists of frequently occurring keywords, etc.). For example, if the input includes statements such as “I want a guitar recently,” “I want to watch a movie this weekend,” or “I'm interested in a new camera,” the analysis unit extracts keywords such as “guitar,” “movie,” and “camera,” and scores the frequency and contextual importance of each keyword. The analysis unit further models changes in user interests and the relationships among multiple interests using time-series analysis and co-occurrence network analysis. The extracted feature quantities are input to the selection unit. The selection unit uses AI models such as gradient boosting decision trees or neural network classifiers to map the input feature vectors to multiple present candidates (e.g., item IDs, service IDs, digital content IDs, etc.) and scores each candidate. Example output includes lists such as “guitar (score 0.92),” “movie ticket (score 0.85),” “camera accessory (score 0.78),” etc. The selection unit performs subsequent processing such as threshold judgment and extraction of the top n ranked items, generating the final proposal list. Unlike conventional human-based simple keyword searches or rule-based recommendations, these processes involve vector operations in high-dimensional feature spaces and integrated analysis of multimodal data, resulting in significant technical improvements in accuracy, reproducibility, and scalability. As a technical effect, this system can automatically extract complex preference patterns unique to each user with high accuracy and speed, and generate optimal present candidates, thereby improving user satisfaction, proposal accuracy, and reducing system operation costs compared to conventional rule-based recommendations or simple questionnaire methods. Specific application fields include personal gift e-commerce sites, corporate welfare systems, event promotion support, and family-oriented applications. Furthermore, advanced techniques such as supervised learning (e.g., minimizing loss functions labeled with past present selection histories and satisfaction ratings), transfer learning, and data augmentation (e.g., synonym replacement and paraphrase generation) can be combined for AI model training. This enables the system to demonstrate high versatility and adaptability even for new users or in data-scarce environments.

The present selection system according to the embodiment comprises a collection unit, an analysis unit, and a selection unit. The collection unit collects talk histories. The talk histories may include, for example, text messages, voice messages, images, but are not limited to such examples. The collection unit may, for example, acquire talk histories from communication applications used by the user. The analysis unit analyzes the talk histories collected by the collection unit. The analysis unit analyzes the talk histories using natural language processing technology. Natural language processing technology may include, for example, morphological analysis, grammatical analysis, semantic analysis, but is not limited to such examples. The analysis unit identifies the preferences and interests of the other party from the talk histories. For example, the analysis unit extracts keywords contained in the talk histories and identifies information about hobbies or desired items that the other party frequently discusses. The selection unit selects a present based on the analysis result obtained by the analysis unit. The selection unit proposes a specific present. For example, the selection unit selects a present such as goods, services, or digital content based on the preferences or interests of the other party. Thus, the present selection system according to the embodiment enables the user to select the optimal present for the other party. Some or all of the above-described processing in the selection unit may be performed using AI, or may be performed without using AI. For example, the selection unit may use an AI model that receives the analysis result obtained by the analysis unit as input and outputs a present to select the present. Specifically, in the present selection system, the collection unit automatically acquires talk history data (e.g., UTF-8 encoded text, WAV/MP3 audio files, JPEG/PNG image files, etc.) from the user's communication applications (e.g., messaging apps, SNS apps, etc.) using APIs or scraping technology. The collection unit organizes the acquired data in chronological order and adds metadata (e.g., sender ID, timestamp, message type). The analysis unit first applies a morphological analyzer (e.g., MeCab) to the text data for word segmentation and part-of-speech tagging, extracts subject-predicate-object structures using a grammatical parser, and generates contextual semantic vectors using a semantic analyzer (e.g., BERT or Transformer-based encoder). Audio data is converted to text using a speech recognition engine (e.g., RNN-T or Transformer ASR), and image data features are extracted using a convolutional neural network (CNN). The analysis unit performs frequent keyword extraction (e.g., TF-IDF or attention weights), topic clustering (e.g., K-means or LDA), and sentiment analysis (e.g., multi-class classifier for emotion labeling) on these diverse data, quantifying the other party's hobbies, interests, and desires as high-dimensional feature vectors. The selection unit receives the feature vectors from the analysis unit and uses AI models such as gradient boosting decision trees or multilayer perceptrons (MLP) to score and rank thousands to tens of thousands of present candidates in the present candidate database. The AI model output is structured data such as “item ID: 12345, score: 0.91,” “service ID: 67890, score: 0.85,” “digital content ID: 54321, score: 0.78,” etc. The selection unit performs subsequent processing such as threshold judgment, extraction of the top n items, and matching with user attributes, generating the final proposal list. This series of processes, unlike conventional human-based simple searches or rule-based recommendations, realizes automatic learning, pattern extraction, and integrated analysis of multimodal data in high-dimensional feature spaces using AI, resulting in significant technical effects such as improved proposal accuracy, processing speed, and user satisfaction. Application fields include gift e-commerce sites, welfare systems, event promotion, and family applications. AI model training can combine advanced techniques such as supervised learning (e.g., minimizing loss functions labeled with past selection histories and satisfaction ratings), transfer learning, and data augmentation (e.g., paraphrase generation, image augmentation).

The analysis unit can analyze talk histories using natural language processing technology. Natural language processing technology may include, for example, morphological analysis, grammatical analysis, semantic analysis, but is not limited to such examples. The analysis unit may use morphological analysis to segment words in the talk histories and identify the part of speech of each word. In addition, the analysis unit may use grammatical analysis to analyze the structure of sentences in the talk histories and identify elements such as subject, predicate, and object. Furthermore, the analysis unit may use semantic analysis to analyze the meaning of sentences in the talk histories and understand the content of the sentences. For example, the analysis unit extracts keywords contained in the talk histories and identifies information about hobbies or desired items that the other party frequently discusses. This enables the analysis unit to improve the accuracy of talk history analysis. Specifically, the analysis unit applies a morphological analyzer (e.g., dictionary-based tokenizer or subword segmentation algorithm) to the talk history data received as input (e.g., UTF-8 encoded text arrays, text sequences from speech recognition results, label sequences from image recognition results), segmenting each sentence into words or subwords. The analysis unit performs part-of-speech tagging (e.g., noun, verb, adjective, etc.) on the segmented word sequences, extracts subject-predicate-object relationships using a grammatical parser (e.g., dependency structure analysis algorithm), and generates semantic vectors for each sentence (e.g., 768-dimensional embedding vectors) using a semantic analyzer (e.g., BERT or Transformer encoder), quantifying contextual meaning. The analysis unit constructs topic-specific feature spaces by clustering (e.g., K-means) or dimensionality reduction (e.g., PCA) of these vectors. The analysis unit also performs frequent keyword extraction (e.g., TF-IDF score calculation or attention weighting) and sentiment analysis (e.g., multi-class classifier for emotion labeling), accurately identifying the user's hobbies, interests, and desires. For example, if the input includes statements such as “I want a guitar recently” or “I want to watch a movie this weekend,” the analysis unit extracts keywords such as “guitar” and “movie,” and calculates their frequency and contextual scores. The analysis unit passes the extracted feature quantities to the selection unit for subsequent present recommendation processing. These processes, unlike conventional simple keyword searches or manual tagging, realize automatic feature extraction, semantic understanding, and pattern recognition in high-dimensional vector spaces, resulting in significant technical effects such as improved analysis accuracy, reproducibility, and scalability. Application fields include gift recommendation, personalized advertising, and customer support automation. The AI model of the analysis unit can be enhanced by combining techniques such as supervised learning (e.g., learning with pairs of statements and hobby labels), transfer learning, and data augmentation (e.g., paraphrase generation).

The selection unit can select a specific present. Specific presents may include, for example, goods, services, digital content, but are not limited to such examples. The selection unit may select goods based on the preferences or interests of the other party. For example, the selection unit can select goods related to hobbies that the other party frequently discusses. In addition, the selection unit may select services based on the preferences or interests of the other party. For example, the selection unit can select tickets for events that the other party is interested in. Furthermore, the selection unit may select digital content based on the preferences or interests of the other party. For example, the selection unit can select digital content such as movies or music that the other party likes. As a result, the selection unit enables the user to select the optimal present for the other party. Specifically, the selection unit receives feature vectors from the analysis unit (e.g., hobby category distribution vectors, emotion score vectors, lists of frequently occurring keywords) as input and matches them with the present candidate database (e.g., item master, service master, digital content master). The selection unit uses AI models such as gradient boosting decision trees or multilayer perceptrons (MLP) to calculate similarity scores between the input feature quantities and attribute vectors of each present candidate (e.g., category, price range, popularity, stock status, etc.). Based on the scoring results, the selection unit extracts the top n present candidates and generates a ranking list. Example output includes structured data such as “item ID: 12345, score: 0.91,” “service ID: 67890, score: 0.85,” “digital content ID: 54321, score: 0.78,” etc. The selection unit further matches user attributes (e.g., age, gender, relationship) and past selection histories to generate the final proposal list. These processes, unlike conventional human-based rule-of-thumb or simple category matching, realize automatic learning, pattern extraction, and integrated analysis of multiple attributes in high-dimensional feature spaces, resulting in significant technical effects such as improved proposal accuracy, user satisfaction, and system operation efficiency. Application fields include gift e-commerce sites, welfare systems, event promotion, and personalized advertising. AI model training can combine advanced techniques such as supervised learning (e.g., minimizing loss functions labeled with past selection histories and satisfaction ratings), transfer learning, and data augmentation (e.g., synthesis of attribute combinations).

The selection unit can select a present based on the preferences or interests of the other party. Preferences or interests of the other party may include, for example, hobbies, desired items, events of interest, but are not limited to such examples. The selection unit may select presents related to hobbies that the other party frequently discusses. For example, if the other party is interested in sports, the selection unit can select sporting goods. In addition, the selection unit may select presents related to desired items of the other party. For example, if the other party wants a product of a specific brand, the selection unit can select products of that brand. Furthermore, the selection unit may select presents related to events that the other party is interested in. For example, if the other party is interested in concerts, the selection unit can select concert tickets. As a result, the selection unit enables the user to select presents that will please the other party. Specifically, the selection unit receives hobby category distribution vectors and keyword frequency lists from the analysis unit as input and performs attribute matching with the present candidate database (e.g., goods, services, digital content, etc.). The selection unit uses neural network classifiers or gradient boosting decision trees to calculate similarity scores between the input feature quantities and attribute vectors of each present candidate (e.g., category, brand, event relevance, etc.). Based on the scoring results, the selection unit extracts the top n present candidates and generates a ranking list. Example output includes structured data such as “sporting goods (score 0.93),” “brand products (score 0.89),” “concert tickets (score 0.85),” etc. The selection unit further matches user attributes and past selection histories to generate the final proposal list. These processes, unlike conventional human-based rule-of-thumb or simple category matching, realize automatic learning, pattern extraction, and integrated analysis of multiple attributes in high-dimensional feature spaces, resulting in significant technical effects such as improved proposal accuracy, user satisfaction, and system operation efficiency. Application fields include gift e-commerce sites, welfare systems, event promotion, and personalized advertising. AI model training can combine advanced techniques such as supervised learning (e.g., minimizing loss functions labeled with past selection histories and satisfaction ratings), transfer learning, and data augmentation (e.g., synthesis of attribute combinations).

A unit for providing the result of present proposals to a user is included. The providing unit provides the result of present proposals to the user. The result of present proposals may include, for example, detailed information about the proposed present, reasons for the proposal, formats of the proposal, but is not limited to such examples. The providing unit may provide detailed information about the proposed present to the user. For example, the providing unit can provide information such as the name, price, and purchase source of the proposed present. In addition, the providing unit may provide the reason for the proposal to the user. For example, the providing unit can explain the reason why the proposed present was selected based on the preferences or interests of the other party. Furthermore, the providing unit may provide the format of the proposal to the user. For example, the providing unit can provide images or videos of the proposed present. As a result, the providing unit enables the user to confirm the proposed present. Specifically, the providing unit displays the present proposal list received from the selection unit (e.g., structured data including item ID, service ID, digital content ID, score, reason text, image URL, etc.) on a user interface (e.g., smartphone app, web dashboard, etc.). For each present candidate, the providing unit presents details such as name, price, purchase URL, stock status, image thumbnail, description, and recommendation reason (e.g., “because the other party has shown interest in guitars”). The providing unit further realizes interactive UI where the user can check the reason for the proposal or detailed information with a single tap, and visual appeal through images or videos. Example output includes “guitar (price: 30,000 yen, purchase source: EC site A, reason: stated recently wanting a guitar),” “movie ticket (price: 2,000 yen, purchase source: EC site B, reason: stated wanting to watch a movie this weekend),” etc. The providing unit records the user's operation history and feedback (e.g., adoption or rejection of proposals, satisfaction ratings, etc.) and utilizes them for subsequent AI model training and improvement of proposal accuracy. These processes, unlike conventional simple list displays or static information provision, realize personalized UI generation that dynamically reflects user attributes, histories, and feedback, and improve the explainability of recommendation reasons, resulting in significant technical effects such as improved user experience, proposal acceptance, and system operation efficiency. Application fields include gift e-commerce sites, welfare systems, event promotion, and personalized advertising.

The collection unit can estimate a user's emotion and adjust the timing of collecting talk histories based on the estimated emotion. For example, if the user is feeling stressed, the collection timing may be delayed so that collection occurs when the user is relaxed. If the user is relaxed, the collection unit may immediately collect the talk history and proceed with analysis. Furthermore, if the user is in a hurry, the collection timing may be accelerated to quickly collect the talk history. Thus, by adjusting the collection timing based on the user's emotion, the collection unit can collect talk histories at more appropriate times. Emotion estimation may be realized using an emotion engine or generative AI, such as a text generation AI (e.g., LLM) or multimodal generative AI, but is not limited to such examples. Some or all of the above-described processing in the collection unit may be performed using AI, or may be performed without using AI. For example, the collection unit may input the user's emotion data to generative AI and have the generative AI perform emotion estimation. Specifically, the collection unit accepts various input data for user emotion estimation, such as talk history text data (e.g., UTF-8 encoded utterance arrays, time-stamped utterance data), audio data (e.g., WAV format audio waveforms, spectrogram images), and image data (e.g., facial expression images, stamp images). The collection unit first performs noise removal, normalization, and feature extraction (e.g., MFCC feature extraction from audio, facial expression feature extraction from images) in the preprocessing unit. Next, an AI model for emotion estimation (e.g., BERT-based emotion classifier, ResNet-based facial expression recognition CNN, RNN for speech emotion recognition, etc.) converts the input data into multidimensional feature vectors (e.g., 768 dimensions for text, 128 for audio, 512 for images) and outputs emotion labels (e.g., relaxed, stressed, excited, sad, etc.) and emotion scores (e.g., probability values for each emotion, such as relaxed 0.82, stressed 0.12, excited 0.06). Example inputs include utterances such as “I've been busy at work and tired lately,” “I'm very happy today,” “I want a reply right away,” as well as images of smiling or frowning faces and audio data of tense voices. Example AI model outputs include “emotion label: stress, score 0.76,” “emotion label: relaxed, score 0.91,” etc. Based on these emotion estimation results, the collection timing control module automatically adjusts the collection timing using rule-based or reinforcement learning algorithms, such as “if stress is high, recollect after 30 minutes,” “if relaxed, collect immediately,” “if in a hurry, collect within 5 minutes.” Subsequently, the collected talk histories are sent to the analysis unit, enabling data analysis optimized for the user's state at the appropriate timing. These processes, unlike conventional fixed-time collection or manual human judgment, combine multimodal emotion estimation by AI and dynamic timing control, resulting in significant technical effects such as reduced user burden, improved data quality, and increased overall system efficiency. Application fields include personalized gift recommendation, mental healthcare support, and user experience optimization applications. AI model training can combine advanced techniques such as supervised learning using emotion-labeled talk history datasets, multimodal integration of speech, image, and text, and data augmentation (e.g., synthesis of emotion patterns). This enables the collection unit to flexibly adapt to different emotion patterns and behavioral characteristics for each user, achieving high-precision, high-efficiency talk history collection that surpasses conventional technology.

The collection unit can analyze a user's past talk histories and select an appropriate collection method. For example, the collection unit may preferentially collect talk histories from messenger applications that the user has frequently used in the past. The collection unit may also adjust the collection frequency based on the amount of the user's past talk histories. Furthermore, the collection unit may preferentially collect talks containing specific keywords based on the content of the user's past talk histories. Thus, by analyzing past talk histories, the collection unit can select the optimal collection method. Some or all of the above-described processing in the collection unit may be performed using AI, or may be performed without using AI. For example, the collection unit may input the user's past talk history data to generative AI and have the generative AI select the optimal collection method. Specifically, the collection unit accepts as input the user's past talk history data (e.g., arrays of text messages by application, utterance logs with transmission dates, metadata of audio and image files, etc.). First, in the preprocessing unit, data is classified and normalized by application type, and the number of utterances and data volume are aggregated. Next, the AI analysis unit uses a natural language processing model (e.g., Transformer-based history analysis model) to extract frequently used applications (e.g., Messenger A, SNS B, etc.), utterance frequency distributions, and keyword occurrence trends (e.g., “guitar,” “travel,” “movie,” etc.) from past talk histories. Example inputs include “1,000 histories in Messenger A, 200 in SNS B,” “‘movie’ appeared 20 times in the past month,” etc. Example AI model outputs include “priority collection app: Messenger A,” “collection frequency: once per day,” “priority keywords: movie, travel,” etc. Based on these analysis results, the collection control module automatically selects the collection method using rule-based or AI optimization algorithms, such as “prioritize collection from frequently used apps,” “extend collection intervals if history volume is high,” “extract only utterances containing specific keywords.” Subsequently, talk histories are acquired in real time or batch according to the selected collection method and sent to the analysis unit. These processes, unlike conventional manual selection or simple periodic collection by humans, combine history pattern analysis by AI and dynamic collection control, resulting in significant technical effects such as improved data acquisition efficiency, reduction of unnecessary data, and decreased system operation costs. Application fields include personalized gift recommendation, customer support automation, and user behavior analysis services. AI model training can combine advanced techniques such as supervised learning labeled with the optimality of collection results based on past history data, clustering of history content, and data augmentation (e.g., synthesis of history patterns). This enables the collection unit to flexibly adapt to different history usage tendencies and data characteristics for each user, achieving high-precision, high-efficiency talk history collection that surpasses conventional technology.

The collection unit can perform filtering based on a user's current interests or events when collecting talk histories. For example, the collection unit may preferentially collect talk histories related to events in which the user is currently interested. The collection unit may also filter and collect talk histories related to hobbies or interests that the user has recently discussed. Furthermore, the collection unit may collect talk histories related to events in which the user is scheduled to participate. Thus, by performing filtering based on current interests or events, the collection unit can collect highly relevant talk histories. Some or all of the above-described processing in the collection unit may be performed using AI, or may be performed without using AI. For example, the collection unit may input data about the user's current interests or events to generative AI and have the generative AI perform filtering. Specifically, the collection unit accepts as input the user's current interests or event information (e.g., calendar events, SNS post content, lists of keywords extracted from recent talk histories, etc.). First, in the preprocessing unit, event names and hobby categories (e.g., “concert,” “travel,” “sports viewing,” etc.) are normalized, and time-series information and relevance scores are added. Next, the AI analysis unit uses a natural language processing model (e.g., Transformer-based interest extraction model) to automatically extract utterances, images, and audio related to current interests or events from talk history data (e.g., text arrays, image labels, speech recognition results, etc.). Example inputs include utterances such as “I'm going to a live concert this weekend,” “I've been into photography lately,” and calendar information containing event names. Example AI model outputs include “related talk history ID list: 123, 456, 789,” “relevance score: 0.92 (live concert), 0.85 (photography),” etc. Based on these analysis results, the collection control module performs filtering using rule-based or AI optimization algorithms, such as “prioritize collection of histories with high relevance scores,” “focus on collecting histories before and after events.” Subsequently, the filtered talk histories are sent to the analysis unit, enabling data analysis tailored to the user's latest interests and events. These processes, unlike conventional full collection or manual selection by humans, combine interest and event extraction by AI and dynamic filtering, resulting in significant technical effects such as efficient acquisition of highly relevant data, reduction of noise data, and improved overall system accuracy. Application fields include personalized gift recommendation, event promotion support, and user behavior analysis services. AI model training can combine advanced techniques such as supervised learning using interest/event-labeled history datasets, clustering of time-series patterns, and data augmentation (e.g., synthesis of event patterns). This enables the collection unit to flexibly adapt to different interest and event patterns for each user, achieving high-precision, high-efficiency talk history collection that surpasses conventional technology.

The collection unit can estimate a user's emotion and determine the priority of talk histories to be collected based on the estimated emotion. For example, if the user is excited, the collection unit may preferentially collect recent talk histories. If the user is calm, the collection unit may preferentially collect past talk histories. Furthermore, if the user is sad, the collection unit may preferentially collect talk histories related to emotions. Thus, by determining the priority based on the user's emotion, the collection unit can preferentially collect more important talk histories. Emotion estimation may be realized using an emotion engine or generative AI, such as a text generation AI (e.g., LLM) or multimodal generative AI, but is not limited to such examples. Some or all of the above-described processing in the collection unit may be performed using AI, or may be performed without using AI. For example, the collection unit may input the user's emotion data to generative AI and have the generative AI determine the priority of talk histories to be collected. Specifically, the collection unit accepts various input data for user emotion estimation, such as talk history text data (e.g., utterance arrays, time-stamped utterance logs), audio data (e.g., audio waveforms, spectrograms), and image data (e.g., facial expression images, stamp images). The collection unit first performs noise removal, normalization, and feature extraction (e.g., MFCC feature extraction from audio, facial expression feature extraction from images) in the preprocessing unit. Next, an AI model for emotion estimation (e.g., BERT-based emotion classifier, ResNet-based facial expression recognition CNN, RNN for speech emotion recognition, etc.) converts the input data into multidimensional feature vectors (e.g., 768 dimensions for text, 128 for audio, 512 for images) and outputs emotion labels (e.g., excitement, calmness, sadness, etc.) and emotion scores (e.g., probability values for each emotion, such as excitement 0.85, calmness 0.10, sadness 0.05). Example inputs include utterances such as “Yay! I'm so happy!” “I want to spend today quietly,” “I've been sad recently,” as well as images of smiling, expressionless, or crying faces, and emotional voice audio data. Example AI model outputs include “emotion label: excitement, score 0.88,” “emotion label: calmness, score 0.92,” “emotion label: sadness, score 0.81,” etc. Based on these emotion estimation results, the collection priority control module automatically determines the priority using rule-based or AI optimization algorithms, such as “prioritize collection of histories from the past 24 hours when excited,” “prioritize collection of histories from the past month when calm,” “prioritize collection of histories containing emotion-related keywords when sad.” Subsequently, prioritized talk histories are sent to the analysis unit, enabling data analysis optimized for the user's emotional state. These processes, unlike conventional simple chronological collection or manual human judgment, combine multimodal emotion estimation by AI and dynamic priority control, resulting in significant technical effects such as rapid acquisition of important data, improved user experience, and increased overall system efficiency. Application fields include personalized gift recommendation, mental healthcare support, and user experience optimization applications. AI model training can combine advanced techniques such as supervised learning using emotion-labeled talk history datasets, multimodal integration, and data augmentation (e.g., synthesis of emotion patterns). This enables the collection unit to flexibly adapt to different emotion patterns and behavioral characteristics for each user, achieving high-precision, high-efficiency talk history collection that surpasses conventional technology.

The collection unit can preferentially collect highly relevant talk histories based on the user's geographic location information when collecting talk histories. For example, if the user is in a specific region, the collection unit may preferentially collect talk histories related to that region. If the user is traveling, the collection unit may preferentially collect talk histories related to the travel destination. Furthermore, if the user is at home, the collection unit may preferentially collect talk histories related to home. Thus, by considering geographic location information, the collection unit can preferentially collect highly relevant talk histories. Some or all of the above-described processing in the collection unit may be performed using AI, or may be performed without using AI. For example, the collection unit may input the user's geographic location information to generative AI and have the generative AI perform preferential collection of highly relevant histories. Specifically, the collection unit accepts as input the user's geographic location information (e.g., GPS coordinates, Wi-Fi location estimation, location history logs, etc.). First, in the preprocessing unit, location information is mapped to place names or categories (e.g., home, workplace, tourist spot, event venue, etc.), and time-series information and movement patterns are extracted. Next, the AI analysis unit combines location information and talk history data (e.g., utterance text, images, audio) and uses natural language processing models or image recognition models to extract location-related keywords (e.g., “Shibuya,” “airport,” “hotel,” etc.) and location-related events (e.g., “travel,” “business trip,” “homecoming,” etc.). Example inputs include utterances such as “I'm in Shibuya now,” “I ate something delicious while traveling,” “I watched a movie at home,” and images with location information. Example AI model outputs include “related talk history ID list: 321, 654, 987,” “relevance score: 0.95 (Shibuya), 0.88 (travel),” etc. Based on these analysis results, the collection control module automatically determines the priority using rule-based or AI optimization algorithms, such as “prioritize collection of histories related to the current location,” “focus on collecting travel-related histories while traveling,” “prioritize collection of home-related histories when at home.” Subsequently, prioritized talk histories are sent to the analysis unit, enabling data analysis optimized for the user's current location and movement status. These processes, unlike conventional full collection or manual selection by humans, combine location information analysis by AI and dynamic priority control, resulting in significant technical effects such as efficient acquisition of highly relevant data, reduction of noise data, and improved overall system accuracy. Application fields include personalized gift recommendation, location-linked services, and event promotion support. AI model training can combine advanced techniques such as supervised learning using location-labeled history datasets, clustering of location patterns, and data augmentation (e.g., synthesis of location events). This enables the collection unit to flexibly adapt to different location and movement patterns for each user, achieving high-precision, high-efficiency talk history collection that surpasses conventional technology.

The collection unit can analyze a user's social media activities and collect relevant talk histories when collecting talk histories. For example, the collection unit may collect talk histories related to topics that the user frequently discusses on social media. The collection unit may also collect talk histories related to accounts followed by the user on social media. Furthermore, the collection unit may collect talk histories related to groups in which the user participates on social media. Thus, by analyzing social media activities, the collection unit can collect relevant talk histories. Some or all of the above-described processing in the collection unit may be performed using AI, or may be performed without using AI. For example, the collection unit may input the user's social media activity data to generative AI and have the generative AI collect relevant histories. Specifically, the collection unit accepts as input the user's social media activity data (e.g., post content, list of followed accounts, group participation information, like history, etc.). First, in the preprocessing unit, post text is normalized, account names and group names are extracted, and time-series information is added. Next, the AI analysis unit uses natural language processing models (e.g., Transformer-based topic extraction models) and graph neural networks (GNN) to extract frequent topics, interest categories, and related accounts/groups from social media activities. Example inputs include data such as “recently, there have been many topics about cameras,” “followed accounts: Photographer A, Travel Info B,” “participating group: Outdoor Enthusiasts,” etc. Example AI model outputs include “related talk history ID list: 111, 222, 333,” “relevance score: 0.93 (camera), 0.87 (outdoor),” etc. Based on these analysis results, the collection control module automatically determines the collection targets using rule-based or AI optimization algorithms, such as “prioritize collection of histories related to frequently discussed topics,” “focus on collecting histories related to followed accounts or participating groups.” Subsequently, highly relevant talk histories are sent to the analysis unit, enabling data analysis tailored to the user's latest interests and network. These processes, unlike conventional full collection or manual selection by humans, combine social graph analysis by AI and dynamic collection control, resulting in significant technical effects such as efficient acquisition of highly relevant data, reduction of noise data, and improved overall system accuracy. Application fields include personalized gift recommendation, SNS-linked services, and user behavior analysis applications. AI model training can combine advanced techniques such as supervised learning using topic/account/group-labeled history datasets, clustering of graph structures, and data augmentation (e.g., synthesis of topic patterns). This enables the collection unit to flexibly adapt to different social activity patterns and network characteristics for each user, achieving high-precision, high-efficiency talk history collection that surpasses conventional technology.

The analysis unit can estimate a user's emotion and adjust the expression method of analysis based on the estimated user's emotion. For example, if the user is relaxed, the analysis unit provides detailed analysis results. If the user is in a hurry, the analysis unit can provide concise analysis results. Furthermore, if the user is excited, the analysis unit can provide visually appealing analysis results. Thus, by adjusting the expression method of analysis based on the user's emotion, the analysis unit can provide more appropriate analysis results. Emotion estimation may be realized using an emotion engine or generative AI, such as a text generation AI (e.g., LLM) or multimodal generative AI, but is not limited to such examples. Some or all of the above-described processing in the analysis unit may be performed using AI, or may be performed without using AI. For example, the analysis unit may input the user's emotion data to generative AI and have the generative AI adjust the expression method of analysis. Specifically, the analysis unit accepts various input data for user emotion estimation, such as talk history text data (e.g., UTF-8 encoded utterance arrays, time-stamped utterance logs), audio data (e.g., WAV format audio waveforms, spectrogram images), and image data (e.g., facial expression images, stamp images). The analysis unit first performs noise removal, normalization, and feature extraction (e.g., MFCC feature extraction from audio, facial expression feature extraction from images) in the preprocessing unit. Next, an AI model for emotion estimation (e.g., BERT-based emotion classifier, ResNet-based facial expression recognition CNN, RNN for speech emotion recognition, etc.) converts the input data into multidimensional feature vectors (e.g., 768 dimensions for text, 128 for audio, 512 for images) and outputs emotion labels (e.g., relaxed, stressed, excited, sad, etc.) and emotion scores (e.g., probability values for each emotion, such as relaxed 0.82, stressed 0.12, excited 0.06). Example inputs include utterances such as “I'm very happy today,” “I want a reply right away,” as well as images of smiling or frowning faces and audio data of tense voices. Example AI model outputs include “emotion label: relaxed, score 0.91,” “emotion label: excited, score 0.76,” etc. Based on these emotion estimation results, the analysis expression control module automatically adjusts the expression method using rule-based or AI optimization algorithms, such as “generate detailed analysis results (e.g., graphs, detailed explanations, supporting data) when relaxed,” “generate summary of key points only when in a hurry,” “generate colorful infographics or animated analysis results when excited.” Subsequently, the adjusted analysis results are sent to the user interface, enabling information presentation optimized for the user's emotional state. These processes, unlike conventional static analysis result displays or manual human judgment, combine multimodal emotion estimation by AI and dynamic expression control, resulting in significant technical effects such as improved user experience, optimized information transmission efficiency, and increased overall system flexibility. Application fields include personalized gift recommendation, mental healthcare support, user experience optimization applications, and educational support systems. AI model training can combine advanced techniques such as supervised learning using emotion-labeled talk history datasets, multimodal integration, and data augmentation (e.g., synthesis of emotion patterns). This enables the analysis unit to flexibly adapt to different emotion patterns and information acceptance characteristics for each user, achieving high-precision, high-efficiency analysis result presentation that surpasses conventional technology.

The analysis unit can adjust the level of detail of analysis based on the importance of the talk histories during analysis. For example, the analysis unit performs detailed analysis for important talk histories. For talk histories of low importance, the analysis unit can perform simplified analysis. Furthermore, the analysis unit can determine the priority of analysis according to the importance of the talk histories. Thus, by adjusting the level of detail of analysis based on the importance of the talk histories, the analysis unit enables efficient analysis. Some or all of the above-described processing in the analysis unit may be performed using AI, or may be performed without using AI. For example, the analysis unit may input importance data of the talk histories to generative AI and have the generative AI adjust the level of detail of analysis. Specifically, the analysis unit accepts talk history data (e.g., utterance text arrays, speech recognition results, image labels, etc.) as input. First, in the preprocessing unit, metadata (e.g., sender, timestamp, related event, keyword occurrence frequency, etc.) is added to each talk history, and an AI model for importance estimation (e.g., Transformer-based importance classifier, gradient boosting decision tree, etc.) calculates an importance score for each history (e.g., 0.95, 0.72, 0.31, etc.). Example inputs include utterances such as “statements about birthdays,” “conversations about recent events,” “daily casual chats,” etc. Example AI model outputs include “history ID: 123, importance: 0.92,” “history ID: 456, importance: 0.45,” etc. Based on these importance scores, the detailed analysis module automatically adjusts the level of detail using rule-based or AI optimization algorithms, such as “perform multi-stage detailed analysis (e.g., morphological analysis, grammatical analysis, semantic analysis, sentiment analysis, topic clustering) for highly important histories,” “perform only keyword extraction or simple summary generation for less important histories.” Furthermore, the analysis unit determines the priority of analysis according to the importance scores and proceeds with analysis in order of importance. Subsequently, analysis results with adjusted level of detail and priority are sent to the selection unit or providing unit, contributing to system-wide resource optimization and improved user experience. These processes, unlike conventional uniform analysis or subjective human judgment, combine importance estimation of histories by AI and dynamic detail control, resulting in significant technical effects such as efficient use of computational resources, improved analysis accuracy, and reduced system operation costs. Application fields include personalized gift recommendation, customer support automation, event promotion support, and business efficiency systems. AI model training can combine advanced techniques such as supervised learning using importance-labeled history datasets, clustering of history content, and data augmentation (e.g., synthesis of importance patterns). This enables the analysis unit to flexibly adapt to different history importance patterns and business requirements for each user, achieving high-precision, high-efficiency analysis that surpasses conventional technology.

The analysis unit can apply different analysis algorithms according to the category of the talk histories during analysis. For example, the analysis unit applies analysis algorithms specialized for hobbies to talk histories related to hobbies. The analysis unit can also apply analysis algorithms specialized for desired items to talk histories related to desired items. Furthermore, the analysis unit can apply analysis algorithms specialized for events to talk histories related to events. Thus, by applying different analysis algorithms according to the category, the analysis unit improves analysis accuracy. Some or all of the above-described processing in the analysis unit may be performed using AI, or may be performed without using AI. For example, the analysis unit may input category data of the talk histories to generative AI and have the generative AI apply different analysis algorithms. Specifically, the analysis unit accepts talk history data (e.g., text arrays, speech recognition results, image labels, etc.) as input. First, in the preprocessing unit, category classification (e.g., hobby, desired item, event, daily conversation, etc.) is performed for each history, and category labels are added. Category classification uses natural language processing models (e.g., BERT-based text classifier, CNN-based image classifier, etc.). Example inputs include utterances such as “I want to watch a movie this weekend,” “I'm interested in a new camera,” “I'm planning to go to a live concert next month,” etc. Example AI model outputs include “history ID: 101, category: hobby,” “history ID: 202, category: desired item,” “history ID: 303, category: event,” etc. The analysis unit automatically applies optimized analysis algorithms for each category (e.g., topic clustering and sentiment analysis for hobby category, product name extraction and purchase intent scoring for desired item category, time-series analysis and event relevance estimation for event category). Furthermore, the analysis unit extracts category-specific features and performs pattern recognition to maximize analysis accuracy. Subsequently, the results analyzed by category are sent to the selection unit, enabling more personalized present recommendations and information presentation. These processes, unlike conventional uniform analysis or human rule-of-thumb methods, combine category recognition by AI and dynamic algorithm selection, resulting in significant technical effects such as improved analysis accuracy, reproducibility, and system flexibility. Application fields include gift recommendation, personalized advertising, customer support automation, and event promotion support. AI model training can combine advanced techniques such as supervised learning using category-labeled history datasets, transfer learning between categories, and data augmentation (e.g., synthesis of category patterns). This enables the analysis unit to flexibly adapt to different category distributions and interest tendencies for each user, achieving high-precision, high-efficiency analysis that surpasses conventional technology.

The analysis unit can estimate a user's emotion and adjust the length of analysis based on the estimated user's emotion. For example, if the user is in a hurry, the analysis unit provides a short, concise analysis result. If the user is relaxed, the analysis unit can provide a detailed analysis result. Furthermore, if the user is excited, the analysis unit can provide a visually appealing analysis result. Thus, by adjusting the length of analysis based on the user's emotion, the analysis unit can provide more appropriate analysis results. Emotion estimation may be realized using an emotion engine or generative AI, such as a text generation AI (e.g., LLM) or multimodal generative AI, but is not limited to such examples. Some or all of the above-described processing in the analysis unit may be performed using AI, or may be performed without using AI. For example, the analysis unit may input the user's emotion data to generative AI and have the generative AI adjust the length of analysis. Specifically, the analysis unit accepts various input data for user emotion estimation, such as talk history text data (e.g., utterance arrays, time-stamped utterance logs), audio data (e.g., audio waveforms, spectrograms), and image data (e.g., facial expression images, stamp images). The analysis unit first performs noise removal, normalization, and feature extraction (e.g., MFCC feature extraction from audio, facial expression feature extraction from images) in the preprocessing unit. Next, an AI model for emotion estimation (e.g., BERT-based emotion classifier, ResNet-based facial expression recognition CNN, RNN for speech emotion recognition, etc.) converts the input data into multidimensional feature vectors (e.g., 768 dimensions for text, 128 for audio, 512 for images) and outputs emotion labels (e.g., hurry, relaxed, excitement, etc.) and emotion scores (e.g., probability values for each emotion, such as hurry 0.81, relaxed 0.14, excitement 0.05). Example inputs include utterances such as “I want to know the result right away,” “I can take it easy today,” “I'm excited,” as well as facial expression images and audio data. Example AI model outputs include “emotion label: hurry, score 0.88,” “emotion label: relaxed, score 0.92,” “emotion label: excitement, score 0.81,” etc. Based on these emotion estimation results, the analysis length control module automatically adjusts the length using rule-based or AI optimization algorithms, such as “generate a short summary of key points only when in a hurry,” “generate a detailed analysis report (e.g., with graphs and supporting explanations) when relaxed,” “generate infographics or animated analysis results when excited.” Subsequently, the adjusted analysis results are sent to the user interface, enabling information presentation optimized for the user's emotional state. These processes, unlike conventional static analysis result displays or manual human judgment, combine multimodal emotion estimation by AI and dynamic length control, resulting in significant technical effects such as improved user experience, optimized information transmission efficiency, and increased overall system flexibility. Application fields include personalized gift recommendation, mental healthcare support, user experience optimization applications, and educational support systems. AI model training can combine advanced techniques such as supervised learning using emotion-labeled talk history datasets, multimodal integration, and data augmentation (e.g., synthesis of emotion patterns). This enables the analysis unit to flexibly adapt to different emotion patterns and information acceptance characteristics for each user, achieving high-precision, high-efficiency analysis result presentation that surpasses conventional technology.

The analysis unit can determine the priority of analysis based on the submission timing of the talk histories during analysis. For example, the analysis unit may preferentially analyze recent talk histories. The analysis unit can also preferentially analyze talk histories before specific events. Furthermore, the analysis unit may preferentially analyze talk histories within a period specified by the user. Thus, by determining the priority of analysis based on the submission timing, the analysis unit enables efficient analysis. Some or all of the above-described processing in the analysis unit may be performed using AI, or may be performed without using AI. For example, the analysis unit may input submission timing data of the talk histories to generative AI and have the generative AI determine the priority of analysis. Specifically, the analysis unit accepts talk history data (e.g., utterance text arrays, time-stamped logs, event information, etc.) as input. First, in the preprocessing unit, metadata such as submission timing and related events is added to each history, and an AI model for submission timing estimation (e.g., time-series analysis model, Transformer-based history classifier, etc.) calculates analysis priority scores (e.g., 0.98, 0.75, 0.32, etc.). Example inputs include utterances such as “yesterday's statement,” “conversation before an event,” “talk from last month,” etc. Example AI model outputs include “history ID: 111, priority: 0.95,” “history ID: 222, priority: 0.41,” etc. Based on these priority scores, the priority analysis module automatically determines the analysis order using rule-based or AI optimization algorithms, such as “preferentially analyze recent histories or histories immediately before events,” “postpone analysis of histories outside the specified period.” Subsequently, prioritized analysis results are sent to the selection unit or providing unit, contributing to system-wide responsiveness and improved user experience. These processes, unlike conventional uniform chronological analysis or manual human judgment, combine submission timing estimation by AI and dynamic priority control, resulting in significant technical effects such as improved analysis efficiency, rapid analysis of important data, and reduced system operation costs. Application fields include personalized gift recommendation, event promotion support, business efficiency systems, and customer support automation. AI model training can combine advanced techniques such as supervised learning using submission timing-labeled history datasets, clustering of time-series patterns, and data augmentation (e.g., synthesis of submission timing patterns). This enables the analysis unit to flexibly adapt to different submission timing patterns and business requirements for each user, achieving high-precision, high-efficiency analysis that surpasses conventional technology.

The analysis unit can adjust the order of analysis based on the relevance of the talk histories during analysis. For example, the analysis unit may preferentially analyze highly relevant talk histories. The analysis unit can also postpone analysis of less relevant talk histories. Furthermore, the analysis unit can dynamically adjust the order of analysis according to the relevance of the talk histories. Thus, by adjusting the order of analysis based on relevance, the analysis unit enables efficient analysis. Some or all of the above-described processing in the analysis unit may be performed using AI, or may be performed without using AI. For example, the analysis unit may input relevance data of the talk histories to generative AI and have the generative AI adjust the order of analysis. Specifically, the analysis unit accepts talk history data (e.g., utterance text arrays, image labels, speech recognition results, etc.) as input. First, in the preprocessing unit, relevance indicators between histories (e.g., number of co-occurring keywords, topic cluster ID, chronological proximity, etc.) are calculated for each history, and an AI model for relevance estimation (e.g., graph neural network, Transformer-based relevance classifier, etc.) calculates relevance scores between histories (e.g., 0.97, 0.63, 0.21, etc.). Example inputs include “multiple statements about the same event,” “consecutive hobby topics,” “unrelated daily conversations,” etc. Example AI model outputs include “history ID: 201, relevance: 0.93,” “history ID: 202, relevance: 0.28,” etc. Based on these relevance scores, the analysis order control module automatically adjusts the order using rule-based or AI optimization algorithms, such as “preferentially analyze highly relevant histories,” “postpone analysis of less relevant histories,” “group highly relevant histories for batch analysis.” Subsequently, adjusted analysis results are sent to the selection unit or providing unit, contributing to improved system-wide analysis efficiency and user experience. These processes, unlike conventional uniform analysis order or subjective human judgment, combine relevance estimation of histories by AI and dynamic order control, resulting in significant technical effects such as improved analysis efficiency, rapid analysis of important data, and reduced system operation costs. Application fields include personalized gift recommendation, event promotion support, business efficiency systems, and customer support automation. AI model training can combine advanced techniques such as supervised learning using relevance-labeled history datasets, clustering of graph structures, and data augmentation (e.g., synthesis of relevance patterns). This enables the analysis unit to flexibly adapt to different history relevance patterns and business requirements for each user, achieving high-precision, high-efficiency analysis that surpasses conventional technology.

The selection unit can estimate a user's emotion and adjust the method of selecting a present based on the estimated user's emotion. For example, if the user is relaxed, the selection unit provides a detailed present selection process. If the user is in a hurry, the selection unit can provide a concise present selection process. Furthermore, if the user is excited, the selection unit can provide a visually appealing present selection process. Thus, by adjusting the method of selecting a present based on the user's emotion, the selection unit can select a more appropriate present. Emotion estimation may be realized using an emotion engine or generative AI, such as a text generation AI (e.g., LLM) or multimodal generative AI, but is not limited to such examples. Some or all of the above-described processing in the selection unit may be performed using AI, or may be performed without using AI. For example, the selection unit may input the user's emotion data to generative AI and have the generative AI adjust the method of selecting a present. Specifically, the selection unit accepts various input data for user emotion estimation, such as talk history text data (e.g., utterance arrays, time-stamped utterance logs), audio data (e.g., audio waveforms, spectrograms), and image data (e.g., facial expression images, stamp images). The selection unit first performs noise removal, normalization, and feature extraction (e.g., MFCC feature extraction from audio, facial expression feature extraction from images) in the preprocessing unit. Next, an AI model for emotion estimation (e.g., BERT-based emotion classifier, ResNet-based facial expression recognition CNN, RNN for speech emotion recognition, etc.) converts the input data into multidimensional feature vectors (e.g., 768 dimensions for text, 128 for audio, 512 for images) and outputs emotion labels (e.g., relaxed, hurry, excitement, etc.) and emotion scores (e.g., probability values for each emotion, such as relaxed 0.82, hurry 0.12, excitement 0.06). Example inputs include utterances such as “I can take it easy today,” “I want to know the result right away,” “I'm excited,” as well as images of smiling, serious, or excited faces, and audio data of calm or excited voices. Example AI model outputs include “emotion label: relaxed, score 0.91,” “emotion label: hurry, score 0.88,” “emotion label: excitement, score 0.81,” etc. Based on these emotion estimation results, the selection process control module automatically adjusts the selection method using rule-based or AI optimization algorithms, such as “provide a detailed selection process (e.g., comparison of multiple candidates, detailed explanation of recommendation reasons, supporting data) when relaxed,” “provide a concise selection process (e.g., immediate proposal of top 1-2 items) when in a hurry,” “provide a visually appealing selection process with infographics or animations when excited.” Subsequently, the adjusted selection process is sent to the user interface, enabling a present selection experience optimized for the user's emotional state. These processes, unlike conventional static selection processes or manual human judgment, combine multimodal emotion estimation by AI and dynamic process control, resulting in significant technical effects such as improved user experience, optimized selection acceptance, and increased overall system flexibility. Application fields include personalized gift recommendation, mental healthcare support, user experience optimization applications, and educational support systems. AI model training can combine advanced techniques such as supervised learning using emotion-labeled talk history datasets, multimodal integration, and data augmentation (e.g., synthesis of emotion patterns). This enables the selection unit to flexibly adapt to different emotion patterns and information acceptance characteristics for each user, achieving high-precision, high-efficiency present selection that surpasses conventional technology.

The selection unit can analyze the other party's past present histories when selecting a present and select an optimal present. For example, the selection unit may select an optimal present based on presents the other party has received in the past. Additionally, the selection unit can select similar presents based on presents that the other party has enjoyed in the past. Furthermore, the selection unit can analyze trends in the presents received by the other party and select an optimal present accordingly. Thus, by analyzing past present histories, the selection unit can select an optimal present. Some or all of the above-described processes in the selection unit may be performed using AI, or may be performed without using AI. For example, the selection unit may input the other party's past present history data into a generative AI and have the generative AI execute the selection of the optimal present. Specifically, the selection unit receives as input the other party's past present history data (e.g., structured data including present ID, category, date of presentation, satisfaction rating, comment feedback, etc.). The selection unit first performs normalization of history data (e.g., category unification, date format conversion), morphological analysis and sentiment analysis of text data (e.g., positive/negative judgment from comment feedback) in a preprocessing unit. Next, using an AI model for history analysis (e.g., Transformer-based history pattern extraction model, gradient boosting decision tree, etc.), trends in past presents (e.g., category distribution, price range, frequency of presentation, time-series changes in satisfaction scores, etc.) are extracted as multidimensional feature vectors. Examples of input data include “5 books, 2 gadgets, 1 trip in the past 3 years,” “Satisfaction scores: books 0.9, gadgets 0.7, trips 1.0,” etc. Examples of AI model output include “Optimal category: travel, recommendation score 0.95,” “Similar present candidates: books (score 0.88), gadgets (score 0.81),” etc. The selection unit matches these analysis results with a present candidate database and preferentially extracts new presents with categories or attributes that received high ratings in the past. Furthermore, time-series changes in history, seasonality, and event relevance are also considered, and patterns such as “books last year, travel this year” are automatically learned. As a subsequent process, the selected present candidates are generated as a ranking list and proposed to the user. This series of processes, which combines high-dimensional history pattern analysis and dynamic recommendation by AI, differs from conventional simple history referencing or human heuristics, and brings about technical effects such as significant improvement in proposal accuracy, user satisfaction, and system operational efficiency. Application fields include gift EC sites, employee benefit systems, event promotion, personalized advertising, etc. For AI model training, advanced methods such as supervised learning using history-labeled datasets, history content clustering, and data augmentation (e.g., synthesis of history patterns) can be combined. As a result, the selection unit flexibly adapts to different history patterns and preference trends for each recipient, achieving highly accurate and efficient present selection that surpasses conventional technology.

The selection unit can customize presents based on the other party's current living situation or events when selecting a present. For example, the selection unit may select a present related to an event in which the other party is currently interested. Additionally, the selection unit can select practical presents based on the other party's current living situation. Furthermore, the selection unit can select presents related to events in which the other party is scheduled to participate. Thus, by customizing presents based on current living situations or events, the selection unit can select more appropriate presents. Some or all of the above-described processes in the selection unit may be performed using AI, or may be performed without using AI. For example, the selection unit may input data regarding the other party's current living situation or events into a generative AI and have the generative AI execute the customization of presents. Specifically, the selection unit receives as input the other party's current living situation or event information (e.g., calendar events, SNS post content, keyword lists extracted from recent talk histories, living pattern estimation data, etc.). The selection unit first normalizes event names and living categories (e.g., “moving,” “promotion,” “wedding,” “travel,” etc.) and assigns time-series information and relevance scores in a preprocessing unit. Next, using an AI model for living situation and event analysis (e.g., Transformer-based event extraction model, time-series clustering model, etc.), features related to current interests or events (e.g., event type, event date, interest score, living change index, etc.) are extracted. Examples of input data include statements such as “attending a wedding next month,” “recently moved to a new home,” “traveling this weekend,” as well as calendar information and SNS posts. Examples of AI model output include “Related event: wedding, relevance 0.93,” “Living situation: new home, relevance 0.88,” etc. The selection unit matches these analysis results with a present candidate database and preferentially extracts presents optimized for events or living situations (e.g., wedding gifts, home appliances for new life, travel goods, etc.). Furthermore, the timing of event occurrence and living changes are considered, and rules such as “prioritize products available for immediate delivery before events,” “emphasize practicality at the start of a new life,” are automatically applied. As a subsequent process, customized present candidates are generated as a ranking list and proposed to the user. This series of processes, which combines living situation and event analysis and dynamic customization recommendation by AI, differs from conventional static category selection or human heuristics, and brings about technical effects such as significant improvement in proposal accuracy, user satisfaction, and system operational efficiency. Application fields include gift EC sites, event promotion support, personalized advertising, life event-linked services, etc. For AI model training, advanced methods such as supervised learning using event/living situation-labeled datasets, time-series pattern clustering, and data augmentation (e.g., synthesis of event patterns) can be combined. As a result, the selection unit flexibly adapts to different living and event patterns for each recipient, achieving highly accurate and efficient present selection that surpasses conventional technology.

The selection unit can estimate a user's emotion and determine the priority of presents based on the estimated emotion. For example, if the user is excited, the selection unit may preferentially select special presents. Additionally, if the user is calm, the selection unit can preferentially select practical presents. Furthermore, if the user is sad, the selection unit can preferentially select presents related to emotions. Thus, by determining the priority of presents based on the user's emotion, the selection unit can select more appropriate presents. Emotion estimation may be realized using an emotion engine or a generative AI, for example, by utilizing an emotion estimation function. The generative AI may be a text generation AI (e.g., LLM) or a multimodal generative AI, but is not limited to these examples. Some or all of the above-described processes in the selection unit may be performed using AI, or may be performed without using AI. For example, the selection unit may input the user's emotion data into a generative AI and have the generative AI execute the determination of present priority. Specifically, the selection unit receives various input data for user emotion estimation, such as text data of talk histories (e.g., utterance sequences, time-stamped utterance logs), audio data (e.g., audio waveforms, spectrograms), and image data (e.g., facial expression images, sticker images). The selection unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., excitement, calmness, sadness, etc.) and emotion scores (e.g., probability values for each emotion, e.g., excitement 0.85, calmness 0.10, sadness 0.05) are output. Examples of input data include utterances such as “Yay! I'm so happy!”, “I want to spend today quietly”, “I've been sad recently”, as well as images of smiling, neutral, or crying faces, and emotional voice audio data. Examples of AI model output include “Emotion label: excitement, score 0.88”, “Emotion label: calmness, score 0.92”, “Emotion label: sadness, score 0.81”, etc. Based on these emotion estimation results, the present priority control module, for example, automatically determines priority using rule-based or AI optimization algorithms, such as “special presents (e.g., limited items, experiential gifts) are ranked higher when excited”, “practical presents (e.g., daily necessities, home appliances) are ranked higher when calm”, “emotion care-related presents (e.g., healing goods, message cards) are ranked higher when sad”. As a subsequent process, prioritized present candidates are generated as a ranking list and proposed to the user. This series of processes, which combines multimodal emotion estimation and dynamic priority control by AI, differs from conventional simple category matching or human heuristics, and brings about technical effects such as significant improvement in proposal accuracy, user satisfaction, and system operational efficiency. Application fields include personalized gift recommendation, mental health care support, user experience optimization applications, etc. For AI model training, advanced methods such as supervised learning using emotion-labeled talk history datasets, multimodal integrated learning, and data augmentation (e.g., synthesis of emotion patterns) can be combined. As a result, the selection unit flexibly adapts to different emotion patterns and behavioral characteristics for each user, achieving highly accurate and efficient present selection that surpasses conventional technology.

The selection unit can select an optimal present by considering the other party's geographic location information when selecting a present. For example, if the other party is in a specific region, the selection unit may select a present related to that region. Additionally, if the other party is traveling, the selection unit can select a present related to the travel destination. Furthermore, if the other party is at home, the selection unit can select a present related to the home. Thus, by considering geographic location information, the selection unit can select an optimal present for the other party. Some or all of the above-described processes in the selection unit may be performed using AI, or may be performed without using AI. For example, the selection unit may input the other party's geographic location information into a generative AI and have the generative AI execute the selection of the optimal present. Specifically, the selection unit receives as input the other party's geographic location information (e.g., GPS coordinates, Wi-Fi location estimation, location history logs, etc.). The selection unit first maps location information to place names or categories (e.g., home, workplace, tourist spot, event venue, etc.) and extracts time-series information and movement patterns in a preprocessing unit. Next, using an AI model for location information analysis (e.g., Transformer-based location relevance estimation model, time-series clustering model, etc.), location-related keywords (e.g., “Shibuya,” “airport,” “hotel,” etc.) and location-related events (e.g., “travel,” “business trip,” “homecoming,” etc.) are extracted. Examples of input data include utterances such as “I'm in Shibuya now,” “I ate something delicious while traveling,” “I watched a movie at home,” as well as location-tagged images. Examples of AI model output include “Related present category: Shibuya limited goods, score 0.95,” “Travel gift, score 0.88,” “Home item, score 0.91,” etc. The selection unit matches these analysis results with a present candidate database and preferentially extracts presents optimized for current location or movement status (e.g., region-limited products, travel goods, home items, etc.). Furthermore, time-series changes in location information and event relevance are considered, and rules such as “prioritize products available for local delivery during travel,” “prioritize courier-compatible products when at home” are automatically applied. As a subsequent process, selected present candidates are generated as a ranking list and proposed to the user. This series of processes, which combines location information analysis and dynamic recommendation by AI, differs from conventional static category selection or human heuristics, and brings about technical effects such as significant improvement in proposal accuracy, user satisfaction, and system operational efficiency. Application fields include gift EC sites, location-linked services, event promotion support, etc. For AI model training, advanced methods such as supervised learning using location-labeled history datasets, location pattern clustering, and data augmentation (e.g., synthesis of location events) can be combined. As a result, the selection unit flexibly adapts to different location and movement patterns for each recipient, achieving highly accurate and efficient present selection that surpasses conventional technology.

The selection unit can analyze the other party's social media activities when selecting a present and select a present accordingly. For example, the selection unit may select a present related to topics frequently mentioned by the other party on social media. Additionally, the selection unit can select a present related to accounts followed by the other party on social media. Furthermore, the selection unit can select a present related to groups in which the other party participates on social media. Thus, by analyzing social media activities, the selection unit can select an optimal present for the other party. Some or all of the above-described processes in the selection unit may be performed using AI, or may be performed without using AI. For example, the selection unit may input the other party's social media activity data into a generative AI and have the generative AI execute the selection of a present. Specifically, the selection unit receives as input the other party's social media activity data (e.g., post content, list of followed accounts, group participation information, like history, etc.). The selection unit first normalizes post text, extracts account names and group names, and assigns time-series information in a preprocessing unit. Next, using an AI model for social media analysis (e.g., Transformer-based topic extraction model, graph neural network, etc.), frequent topics, interest categories, and related accounts/groups are extracted. Examples of input data include “Recently, there have been many topics about cameras,” “Followed accounts: Photographer A, Travel Info B,” “Participating group: Outdoor Enthusiasts,” etc. Examples of AI model output include “Related present category: camera accessories, score 0.93,” “Outdoor goods, score 0.87,” etc. The selection unit matches these analysis results with a present candidate database and preferentially extracts presents optimized for the latest interests and concerns based on social media activities (e.g., trending gadgets, products related to followed accounts, items for group activities, etc.). Furthermore, time-series changes in topics and frequency of group activities are considered, and rules such as “prioritize categories that have recently become topics,” “prioritize related products before group events” are automatically applied. As a subsequent process, selected present candidates are generated as a ranking list and proposed to the user. This series of processes, which combines social graph analysis and dynamic recommendation by AI, differs from conventional static category selection or human heuristics, and brings about technical effects such as significant improvement in proposal accuracy, user satisfaction, and system operational efficiency. Application fields include personalized gift recommendation, SNS-linked services, user behavior analysis applications, etc. For AI model training, advanced methods such as supervised learning using topic/account/group-labeled history datasets, graph structure clustering, and data augmentation (e.g., synthesis of topic patterns) can be combined. As a result, the selection unit flexibly adapts to different social activity patterns and network characteristics for each recipient, achieving highly accurate and efficient present selection that surpasses conventional technology.

The providing unit can estimate a user's emotion and adjust the display method of present proposals based on the estimated emotion. For example, if the user is nervous, the providing unit offers a simple and highly visible display method. Additionally, if the user is relaxed, the providing unit can offer a display method that includes detailed information. Furthermore, if the user is in a hurry, the providing unit can offer a display method that focuses on key points. Thus, by adjusting the display method based on the user's emotion, the providing unit can provide more appropriate present proposals. Emotion estimation may be realized using an emotion engine or a generative AI, for example, by utilizing an emotion estimation function. The generative AI may be a text generation AI (e.g., LLM) or a multimodal generative AI, but is not limited to these examples. Some or all of the above-described processes in the providing unit may be performed using AI, or may be performed without using AI. For example, the providing unit may input the user's emotion data into a generative AI and have the generative AI execute the adjustment of the display method. Specifically, the providing unit receives various input data for user emotion estimation, such as text data of talk histories (e.g., UTF-8 encoded utterance sequences, time-stamped utterance logs), audio data (e.g., WAV format audio waveforms, spectrogram images), and image data (e.g., facial expression images, sticker images). The providing unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., nervousness, relaxation, hurry, etc.) and emotion scores (e.g., probability values for each emotion, e.g., nervousness 0.73, relaxation 0.21, hurry 0.06) are output. Examples of input data include utterances such as “I'm nervous,” “I can relax today,” “I'm in a hurry,” as well as images of nervous facial expressions and audio data of calm voices. Examples of AI model output include “Emotion label: nervousness, score 0.81,” “Emotion label: relaxation, score 0.92,” “Emotion label: hurry, score 0.88,” etc. Based on these emotion estimation results, the display method control module, for example, automatically adjusts the display method using rule-based or AI optimization algorithms, such as “generate a simple UI (e.g., large buttons, minimal information display) when nervous,” “generate a rich UI with detailed information (e.g., product description, images, recommendation reasons, reviews, etc.) when relaxed,” “generate a summary display with only key points (e.g., product name and purchase button only) when in a hurry.” As a subsequent process, the adjusted display method is sent to the user interface (e.g., smartphone app, web dashboard, etc.), and information presentation optimized for the user's emotional state is realized. This series of processes, which combines multimodal emotion estimation and dynamic UI control by AI, differs from conventional static screen design or manual human judgment, and brings about technical effects such as improvement in user experience, optimization of information transmission efficiency, and enhancement of overall system flexibility. Application fields include personalized gift recommendation, mental health care support, user experience optimization applications, educational support systems, etc. For AI model training, advanced methods such as supervised learning using emotion-labeled talk history datasets, multimodal integrated learning, and data augmentation (e.g., synthesis of emotion patterns) can be combined. As a result, the providing unit flexibly adapts to different emotion patterns and information reception characteristics for each user, achieving highly accurate and efficient present proposal display that surpasses conventional technology.

The providing unit can refer to the user's past proposal histories when proposing a present and select an optimal display method. For example, the providing unit may offer a display method based on the display methods the user preferred in the past. Additionally, the providing unit can preferentially propose display methods that the user has used in the past. Furthermore, the providing unit can predict and propose specific display methods based on the user's past proposal histories. Thus, by referring to past proposal histories, the providing unit can select an optimal display method. Some or all of the above-described processes in the providing unit may be performed using AI, or may be performed without using AI. For example, the providing unit may input the user's past proposal history data into a generative AI and have the generative AI execute the selection of the optimal display method. Specifically, the providing unit receives as input the user's past proposal history data (e.g., display method ID, display format (list, card, grid, etc.), device used, display time, user operation history, satisfaction rating, feedback comments, etc., as structured data). The providing unit first performs normalization of history data (e.g., unification of display format categories, time format conversion), aggregation of operation history, and calculation of satisfaction scores in a preprocessing unit. Next, using an AI model for history analysis (e.g., Transformer-based history pattern extraction model, gradient boosting decision tree, etc.), trends in past display methods (e.g., usage frequency distribution, time-series changes in satisfaction scores, device preferences, etc.) are extracted as multidimensional feature vectors. Examples of input data include “Used card display 10 times in the past month, satisfaction 4.5,” “Prefers list display when using a smartphone,” etc. Examples of AI model output include “Recommended display method: card, score 0.92,” “Recommended display method: list, score 0.87,” etc. Based on these analysis results, the display method control module automatically determines the display method using rule-based or AI optimization algorithms, such as “prioritize display methods with high ratings in the past,” “automatically select the optimal display method according to device and time of day,” “conduct A/B testing of new display methods and learn user responses.” As a subsequent process, the selected display method is sent to the user interface, and information presentation optimized for the user's history and preferences is realized. This series of processes, which combines history pattern analysis and dynamic UI control by AI, differs from conventional static screen design or manual human judgment, and brings about technical effects such as improvement in user experience, optimization of information transmission efficiency, and enhancement of overall system flexibility. Application fields include personalized gift recommendation, personalized UI for EC sites, user experience optimization applications, etc. For AI model training, advanced methods such as supervised learning using history-labeled datasets, history content clustering, and data augmentation (e.g., synthesis of display patterns) can be combined. As a result, the providing unit flexibly adapts to different history patterns and display preferences for each user, achieving highly accurate and efficient present proposal display that surpasses conventional technology.

The providing unit can estimate a user's emotion and adjust the operation procedure of present proposals based on the estimated emotion. For example, if the user is nervous, the operation procedure is simplified to allow intuitive operation. Additionally, if the user is relaxed, the providing unit can offer detailed operation procedures and propose customizable options. Furthermore, if the user is in a hurry, the providing unit can offer voice input or shortcuts to enable rapid operation. Thus, by adjusting the operation procedure based on the user's emotion, the providing unit can provide more appropriate present proposals. Emotion estimation may be realized using an emotion engine or a generative AI, for example, by utilizing an emotion estimation function. The generative AI may be a text generation AI (e.g., LLM) or a multimodal generative AI, but is not limited to these examples. Some or all of the above-described processes in the providing unit may be performed using AI, or may be performed without using AI. For example, the providing unit may input the user's emotion data into a generative AI and have the generative AI execute the adjustment of the operation procedure. Specifically, the providing unit receives various input data for user emotion estimation, such as text data of talk histories (e.g., UTF-8 encoded utterance sequences, time-stamped utterance logs), audio data (e.g., WAV format audio waveforms, spectrogram images), and image data (e.g., facial expression images, sticker images). The providing unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., nervousness, relaxation, hurry, etc.) and emotion scores (e.g., probability values for each emotion, e.g., nervousness 0.73, relaxation 0.21, hurry 0.06) are output. Examples of input data include utterances such as “I'm nervous,” “I can relax today,” “I'm in a hurry,” as well as images of nervous facial expressions and audio data of calm voices. Examples of AI model output include “Emotion label: nervousness, score 0.81,” “Emotion label: relaxation, score 0.92,” “Emotion label: hurry, score 0.88,” etc. Based on these emotion estimation results, the operation procedure control module, for example, automatically adjusts the operation procedure using rule-based or AI optimization algorithms, such as “minimize operation steps and generate a one-tap completion UI when nervous,” “display detailed customization options and help guides when relaxed,” “enable voice input and shortcut buttons for rapid operation when in a hurry.” As a subsequent process, the adjusted operation procedure is sent to the user interface, and an operation experience optimized for the user's emotional state is realized. This series of processes, which combines multimodal emotion estimation and dynamic UI control by AI, differs from conventional static operation flows or manual human judgment, and brings about technical effects such as improvement in user experience, optimization of operation efficiency, and enhancement of overall system flexibility. Application fields include personalized gift recommendation, user experience optimization applications, educational support systems, accessibility support, etc. For AI model training, advanced methods such as supervised learning using emotion-labeled talk history datasets, multimodal integrated learning, and data augmentation (e.g., synthesis of emotion patterns) can be combined. As a result, the providing unit flexibly adapts to different emotion patterns and operation characteristics for each user, achieving highly accurate and efficient present proposal operation that surpasses conventional technology.

The providing unit can select an optimal display method by considering the user's device information when proposing a present. For example, if the user is using a smartphone, the providing unit offers a display method adapted to the screen size. Additionally, if the user is using a tablet, the providing unit can offer a display method optimized for a larger screen. Furthermore, if the user is using a smartwatch, the providing unit can offer a concise and highly visible display method. Thus, by considering device information, the providing unit can select an optimal display method. Some or all of the above-described processes in the providing unit may be performed using AI, or may be performed without using AI. For example, the providing unit may input the user's device information into a generative AI and have the generative AI execute the selection of the optimal display method. Specifically, the providing unit receives as input the user's device information (e.g., device type (smartphone, tablet, smartwatch, etc.), screen resolution, OS version, input interface (touch, voice, gesture, etc.), usage environment (indoor/outdoor), etc., as structured data). The providing unit first normalizes device information (e.g., categorization of screen size, unification of OS type), and determines usage environment in a preprocessing unit. Next, using an AI model for device optimization (e.g., Transformer-based UI optimization model, decision tree, etc.), the device characteristics and past usage history are combined to estimate the optimal display method (e.g., list, card, grid, icon, etc.) and UI layout (e.g., button arrangement, font size, image display method, etc.). Examples of input data include “smartphone, screen resolution 1080×2400, touch operation,” “tablet, screen resolution 2048×1536, outdoor use,” etc. Examples of AI model output include “Recommended display method: card, large font size, score 0.91,” “Recommended display method: grid, image emphasis, score 0.87,” etc. Based on these analysis results, the display method control module automatically determines the display method using rule-based or AI optimization algorithms, such as “vertical scroll UI for smartphones,” “multi-column display for tablets,” “concise one-information-per-screen display for smartwatches.” As a subsequent process, the selected display method is sent to the user interface, and information presentation optimized for the user's device characteristics is realized. This series of processes, which combines device characteristic analysis and dynamic UI control by AI, differs from conventional uniform screen design or manual human judgment, and brings about technical effects such as improvement in user experience, optimization of information transmission efficiency, and enhancement of overall system flexibility. Application fields include personalized gift recommendation, multi-device compatible EC sites, user experience optimization applications, accessibility support, etc. For AI model training, advanced methods such as supervised learning using device-labeled usage history datasets, UI pattern clustering, and data augmentation (e.g., synthesis of device patterns) can be combined. As a result, the providing unit flexibly adapts to different device usage patterns and display preferences for each user, achieving highly accurate and efficient present proposal display that surpasses conventional technology.

The system according to the embodiment is not limited to the examples described above, and various modifications are possible, for example, as follows. Specifically, the system can realize diverse variations in terms of AI model architecture, data flow, input/output specifications, user interface design, database configuration, communication protocols, security methods, and other aspects. The system can utilize a combination of AI models such as Transformer-based large language models, convolutional neural networks, recurrent neural networks, graph neural networks, gradient boosting decision trees, self-supervised learning models, and reinforcement learning agents. The system can flexibly switch data flows such as real-time streaming processing, batch processing, distributed edge device processing, and cloud collaboration processing. The system can support user interfaces such as smartphone apps, web dashboards, smartwatches, voice assistants, AR/VR devices, and generate UI/UX optimized for each device characteristic. The system can utilize a combination of databases such as relational databases, NoSQL databases, graph databases, and time-series databases. The system can adopt communication protocols such as HTTPS, WebSocket, MQTT, gRPC, and implement security methods such as TLS encryption, OAuth authentication, and zero-trust networks. Furthermore, the system can flexibly combine learning methods for AI models, such as supervised learning, unsupervised learning, transfer learning, multitask learning, and data augmentation (e.g., paraphrase generation, image enhancement, history pattern synthesis, etc.). Through these diverse configurations and implementation variations, the system realizes highly accurate and efficient gift recommendation and information presentation optimized for each user and application, and exhibits technical effects that surpass conventional technology. Application fields include gift EC sites, employee benefit systems, event promotion, personalized advertising, educational support, mental health care, IoT-linked services, and more.

The analysis unit can estimate a user's emotion and adjust the priority of analysis based on the estimated emotion. For example, if the user is excited, the analysis unit preferentially analyzes recent talk histories. Additionally, if the user is calm, the analysis unit can preferentially analyze past talk histories. Furthermore, if the user is sad, the analysis unit can preferentially analyze talk histories related to emotions. Thus, by adjusting the priority of analysis based on the user's emotion, the analysis unit can preferentially analyze more important talk histories. Specifically, the analysis unit receives various input data for user emotion estimation, such as text data of talk histories (e.g., utterance sequences, time-stamped utterance logs), audio data (e.g., audio waveforms, spectrograms), and image data (e.g., facial expression images, sticker images). The analysis unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., excitement, calmness, sadness, etc.) and emotion scores (e.g., probability values for each emotion, e.g., excitement 0.85, calmness 0.10, sadness 0.05) are output. Examples of input data include utterances such as “Yay! I'm so happy!”, “I want to spend today quietly”, “I've been sad recently”, as well as images of smiling, neutral, or crying faces, and emotional voice audio data. Examples of AI model output include “Emotion label: excitement, score 0.88”, “Emotion label: calmness, score 0.92”, “Emotion label: sadness, score 0.81”, etc. Based on these emotion estimation results, the analysis priority control module automatically determines priority using rule-based or AI optimization algorithms, such as “prioritize analysis of histories from the last 24 hours when excited”, “prioritize analysis of histories from the past month when calm”, “prioritize analysis of histories containing emotion-related keywords when sad”. As a subsequent process, prioritized talk histories are sent to a detailed analysis module, and data analysis optimized for the user's emotional state is realized. This series of processes, which combines multimodal emotion estimation and dynamic priority control by AI, differs from conventional simple time-series analysis or manual human judgment, and brings about technical effects such as rapid analysis of important data, improvement of user experience, and overall system efficiency. Application fields include personalized gift recommendation, mental health care support, user experience optimization applications, etc. For AI model training, advanced methods such as supervised learning using emotion-labeled talk history datasets, multimodal integrated learning, and data augmentation (e.g., synthesis of emotion patterns) can be combined. As a result, the analysis unit flexibly adapts to different emotion patterns and behavioral characteristics for each user, achieving highly accurate and efficient talk history analysis that surpasses conventional technology.

The collection unit can analyze a user's past talk histories and select an appropriate collection method. For example, the collection unit may preferentially collect talk histories from messenger apps that the user has frequently used in the past. Additionally, the collection unit can adjust the collection frequency based on the amount of the user's past talk histories. Furthermore, the collection unit can preferentially collect talks containing specific keywords based on the content of the user's past talk histories. Thus, by analyzing past talk histories, the collection unit can select an optimal collection method. Specifically, the collection unit receives as input the user's past talk history data (e.g., text utterance sequences, metadata of voice messages, image transmission history, app usage logs, etc.). The collection unit first performs normalization of history data (e.g., unification of app names, standardization of timestamps), morphological analysis of utterance content, keyword extraction, and aggregation of transmission frequency in a preprocessing unit. Next, using an AI model for history analysis (e.g., Transformer-based history pattern extraction model, gradient boosting decision tree, etc.), past usage trends (e.g., usage frequency distribution by app, category distribution of utterance content, keyword occurrence frequency, time-series changes in history volume, etc.) are extracted as multidimensional feature vectors. Examples of input data for the AI model include “Number of utterances in Messenger A in the past month: 120, Messenger B: 15,” “Keyword occurrence frequency: travel 10 times, camera 8 times, music 5 times,” etc. Examples of AI model output include “Priority collection app: Messenger A, score 0.93,” “Collection frequency: high (weekly), score 0.88,” “Priority keywords: travel, camera,” etc. Based on these analysis results, the collection control module automatically determines the collection method using rule-based or AI optimization algorithms, such as “preferentially acquire histories from frequently used apps,” “shorten collection intervals when history volume is large,” “extract only histories containing specific keywords.” As a subsequent process, the optimized collection results are sent to the analysis unit, and data analysis tailored to the user's behavioral characteristics and interests is realized. This series of processes, which combines history pattern analysis and dynamic collection control by AI, differs from conventional full collection or manual human selection, and brings about technical effects such as efficient acquisition of highly relevant data, reduction of noise data, and improvement of overall system accuracy. Application fields include personalized gift recommendation, user behavior analysis services, customer support automation, business efficiency systems, etc. For AI model training, advanced methods such as supervised learning using history-labeled datasets, history content clustering, and data augmentation (e.g., synthesis of history patterns) can be combined. As a result, the collection unit flexibly adapts to different history patterns and usage trends for each user, achieving highly accurate and efficient talk history collection that surpasses conventional technology.

The selection unit can estimate a user's emotion and adjust the method of selecting a present based on the estimated emotion. For example, if the user is relaxed, the selection unit provides a detailed present selection process. Additionally, if the user is in a hurry, the selection unit can provide a concise present selection process. Furthermore, if the user is excited, the selection unit can provide a visually appealing present selection process. Thus, by adjusting the present selection method based on the user's emotion, the selection unit can select more appropriate presents. Specifically, the selection unit receives various input data for user emotion estimation, such as text data of talk histories (e.g., utterance sequences, time-stamped utterance logs), audio data (e.g., audio waveforms, spectrograms), and image data (e.g., facial expression images, sticker images). The selection unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., relaxation, hurry, excitement, etc.) and emotion scores (e.g., probability values for each emotion, e.g., relaxation 0.82, hurry 0.12, excitement 0.06) are output. Examples of input data include utterances such as “I can relax today,” “I want to know the result immediately,” “I'm excited,” as well as images of smiling, serious, or excited faces, and audio data of calm or lively voices. Examples of AI model output include “Emotion label: relaxation, score 0.91,” “Emotion label: hurry, score 0.88,” “Emotion label: excitement, score 0.81,” etc. Based on these emotion estimation results, the selection process control module automatically adjusts the selection method using rule-based or AI optimization algorithms, such as “provide a detailed selection process (e.g., comparison of multiple candidates, detailed explanation of recommendation reasons, supporting data) when relaxed,” “provide a concise selection process (e.g., immediate proposal of top 1-2 items) when in a hurry,” “provide a visually appealing selection process with infographics or animations when excited.” As a subsequent process, the adjusted selection process is sent to the user interface, and a present selection experience optimized for the user's emotional state is realized. This series of processes, which combines multimodal emotion estimation and dynamic process control by AI, differs from conventional static selection processes or manual human judgment, and brings about technical effects such as improvement in user experience, optimization of selection satisfaction, and enhancement of overall system flexibility. Application fields include personalized gift recommendation, mental health care support, user experience optimization applications, educational support systems, etc. For AI model training, advanced methods such as supervised learning using emotion-labeled talk history datasets, multimodal integrated learning, and data augmentation (e.g., synthesis of emotion patterns) can be combined. As a result, the selection unit flexibly adapts to different emotion patterns and information reception characteristics for each user, achieving highly accurate and efficient present selection that surpasses conventional technology.

The providing unit can refer to the user's past proposal histories when proposing a present and select an optimal display method. For example, the providing unit may offer a display method based on the display methods the user preferred in the past. Additionally, the providing unit can preferentially propose display methods that the user has used in the past. Furthermore, the providing unit can predict and propose specific display methods based on the user's past proposal histories. Thus, by referring to past proposal histories, the providing unit can select an optimal display method. Specifically, the providing unit receives as input the user's past proposal history data (e.g., display method ID, display format (list, card, grid, etc.), device used, display time, user operation history, satisfaction rating, feedback comments, etc., as structured data). The providing unit first performs normalization of history data (e.g., unification of display format categories, time format conversion), aggregation of operation history, and calculation of satisfaction scores in a preprocessing unit. Next, using an AI model for history analysis (e.g., Transformer-based history pattern extraction model, gradient boosting decision tree, etc.), trends in past display methods (e.g., usage frequency distribution, time-series changes in satisfaction scores, device preferences, etc.) are extracted as multidimensional feature vectors. Examples of input data for the AI model include “Used card display 10 times in the past month, satisfaction 4.5,” “Prefers list display when using a smartphone,” etc. Examples of AI model output include “Recommended display method: card, score 0.92,” “Recommended display method: list, score 0.87,” etc. Based on these analysis results, the display method control module automatically determines the display method using rule-based or AI optimization algorithms, such as “prioritize display methods with high ratings in the past,” “automatically select the optimal display method according to device and time of day,” “conduct A/B testing of new display methods and learn user responses.” As a subsequent process, the selected display method is sent to the user interface, and information presentation optimized for the user's history and preferences is realized. This series of processes, which combines history pattern analysis and dynamic UI control by AI, differs from conventional static screen design or manual human judgment, and brings about technical effects such as improvement in user experience, optimization of information transmission efficiency, and enhancement of overall system flexibility. Application fields include personalized gift recommendation, personalized UI for EC sites, user experience optimization applications, etc. For AI model training, advanced methods such as supervised learning using history-labeled datasets, history content clustering, and data augmentation (e.g., synthesis of display patterns) can be combined. As a result, the providing unit flexibly adapts to different history patterns and display preferences for each user, achieving highly accurate and efficient present proposal display that surpasses conventional technology.

The analysis unit can apply different analysis algorithms according to the category of talk histories during analysis. For example, for talk histories related to hobbies, the analysis unit applies algorithms specialized for hobbies. For talk histories related to desired items, the analysis unit applies algorithms specialized for desired items. Furthermore, for talk histories related to events, the analysis unit applies algorithms specialized for events. Thus, by applying different analysis algorithms according to the category, the analysis unit improves analysis accuracy. Specifically, the analysis unit receives talk history data (e.g., text sequences, speech recognition results, image labels, etc.) as input. The analysis unit first performs category classification for each history (e.g., hobby, desired item, event, daily conversation, etc.) and assigns category labels in a preprocessing unit. Category classification uses natural language processing models (e.g., BERT-based text classifier, CNN-based image classifier, etc.). Examples of input data for the AI model include utterances such as “I want to watch a movie this weekend,” “I'm interested in a new camera,” “I'm planning to go to a live event next month,” etc. Examples of AI model output include “History ID: 101, Category: hobby,” “History ID: 202, Category: desired item,” “History ID: 303, Category: event,” etc. The analysis unit automatically applies optimized analysis algorithms for each category (e.g., topic clustering and sentiment analysis for hobby category, product name extraction and purchase intent scoring for desired item category, time-series analysis and event relevance estimation for event category, etc.). Furthermore, the analysis unit performs feature extraction and pattern recognition for each category to maximize analysis accuracy. As a subsequent process, the results analyzed by category are sent to the selection unit, and more personalized present recommendation and information presentation are realized. This series of processes, which combines category recognition and dynamic algorithm selection by AI, differs from conventional uniform analysis or human heuristics, and brings about technical effects such as significant improvement in analysis accuracy, reproducibility, and system flexibility. Application fields include gift recommendation, personalized advertising, customer support automation, event promotion support, etc. For AI model training, advanced methods such as supervised learning using category-labeled history datasets, transfer learning between categories, and data augmentation (e.g., synthesis of category patterns) can be combined. As a result, the analysis unit flexibly adapts to different category distributions and interest trends for each user, achieving highly accurate and efficient analysis that surpasses conventional technology.

The providing unit can estimate a user's emotion and adjust the display method of present proposals based on the estimated emotion. For example, if the user is nervous, the providing unit offers a simple and highly visible display method. Additionally, if the user is relaxed, the providing unit can offer a display method that includes detailed information. Furthermore, if the user is in a hurry, the providing unit can offer a display method that focuses on key points. Thus, by adjusting the display method based on the user's emotion, the providing unit can provide more appropriate present proposals. Specifically, the providing unit receives various input data for user emotion estimation, such as text data of talk histories (e.g., UTF-8 encoded utterance sequences, time-stamped utterance logs), audio data (e.g., WAV format audio waveforms, spectrogram images), and image data (e.g., facial expression images, sticker images). The providing unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., nervousness, relaxation, hurry, etc.) and emotion scores (e.g., probability values for each emotion, e.g., nervousness 0.73, relaxation 0.21, hurry 0.06) are output. Examples of input data include utterances such as “I'm nervous,” “I can relax today,” “I'm in a hurry,” as well as images of nervous facial expressions and audio data of calm voices. Examples of AI model output include “Emotion label: nervousness, score 0.81,” “Emotion label: relaxation, score 0.92,” “Emotion label: hurry, score 0.88,” etc. Based on these emotion estimation results, the display method control module, for example, automatically adjusts the display method using rule-based or AI optimization algorithms, such as “generate a simple UI (e.g., large buttons, minimal information display) when nervous,” “generate a rich UI with detailed information (e.g., product description, images, recommendation reasons, reviews, etc.) when relaxed,” “generate a summary display with only key points (e.g., product name and purchase button only) when in a hurry.” As a subsequent process, the adjusted display method is sent to the user interface (e.g., smartphone app, web dashboard, etc.), and information presentation optimized for the user's emotional state is realized. This series of processes, which combines multimodal emotion estimation and dynamic UI control by AI, differs from conventional static screen design or manual human judgment, and brings about technical effects such as improvement in user experience, optimization of information transmission efficiency, and enhancement of overall system flexibility. Application fields include personalized gift recommendation, mental health care support, user experience optimization applications, educational support systems, etc. For AI model training, advanced methods such as supervised learning using emotion-labeled talk history datasets, multimodal integrated learning, and data augmentation (e.g., synthesis of emotion patterns) can be combined. As a result, the providing unit flexibly adapts to different emotion patterns and information reception characteristics for each user, achieving highly accurate and efficient present proposal display that surpasses conventional technology.

The collection unit can perform filtering based on a user's current interests or events when collecting talk histories. For example, the collection unit may preferentially collect talk histories related to events in which the user is currently interested. Additionally, the collection unit can filter and collect talk histories related to hobbies or interests that the user has recently mentioned. Furthermore, the collection unit can collect talk histories related to events in which the user is scheduled to participate. Thus, by performing filtering based on current interests or events, the collection unit can collect highly relevant talk histories. Specifically, the collection unit receives as input the user's current interests or event information (e.g., calendar events, SNS post content, keyword lists extracted from recent talk histories, etc.). The collection unit first normalizes event names and hobby categories (e.g., “concert,” “travel,” “sports viewing,” etc.) and assigns time-series information and relevance scores in a preprocessing unit. Next, the AI analysis unit uses a natural language processing model (e.g., Transformer-based interest extraction model) to automatically extract utterances, images, and audio related to current interests or events from talk history data (e.g., text sequences, image labels, speech recognition results, etc.). Examples of input data include utterances such as “I'm going to a live concert this weekend,” “I've recently gotten into photography,” as well as calendar information containing event names. Examples of AI model output include “Related talk history ID list: 123, 456, 789,” “Relevance score: 0.92 (live concert), 0.85 (photography),” etc. Based on these analysis results, the collection control module executes filtering using rule-based or AI optimization algorithms, such as “preferentially collect histories with high relevance scores,” “focus on collecting histories before and after event occurrence.” As a subsequent process, the filtered talk histories are sent to the analysis unit, and data analysis tailored to the user's latest interests and events is realized. This series of processes, which combines interest/event extraction and dynamic filtering by AI, differs from conventional full collection or manual human selection, and brings about technical effects such as efficient acquisition of highly relevant data, reduction of noise data, and improvement of overall system accuracy. Application fields include personalized gift recommendation, event promotion support, user behavior analysis services, etc. For AI model training, advanced methods such as supervised learning using interest/event-labeled history datasets, time-series pattern clustering, and data augmentation (e.g., synthesis of event patterns) can be combined. As a result, the collection unit flexibly adapts to different interest and event patterns for each user, achieving highly accurate and efficient talk history collection that surpasses conventional technology.

The analysis unit can estimate a user's emotion and adjust the expression method of analysis based on the estimated emotion. For example, if the user is relaxed, the analysis unit provides detailed analysis results. Additionally, if the user is in a hurry, the analysis unit can provide concise analysis results. Furthermore, if the user is excited, the analysis unit can provide visually appealing analysis results. Thus, by adjusting the expression method of analysis based on the user's emotion, the analysis unit can provide more appropriate analysis results. Specifically, the analysis unit receives various input data for user emotion estimation, such as text data of talk histories (e.g., UTF-8 encoded utterance sequences, time-stamped utterance logs), audio data (e.g., WAV format audio waveforms, spectrogram images), and image data (e.g., facial expression images, sticker images). The analysis unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., relaxation, stress, excitement, sadness, etc.) and emotion scores (e.g., probability values for each emotion, e.g., relaxation 0.82, stress 0.12, excitement 0.06) are output. Examples of input data include utterances such as “I'm having a lot of fun today,” “I want a reply right away,” as well as images of smiling or frowning faces, and audio data of tense voices. Examples of AI model output include “Emotion label: relaxation, score 0.91,” “Emotion label: excitement, score 0.76,” etc. Based on these emotion estimation results, the analysis expression control module automatically adjusts the expression method using rule-based or AI optimization algorithms, such as “generate detailed analysis results (e.g., graphs, detailed explanations, supporting data) when relaxed,” “generate summaries with only key points when in a hurry,” “generate colorful infographics or animated analysis results when excited.” As a subsequent process, the adjusted analysis results are sent to the user interface, and information presentation optimized for the user's emotional state is realized. This series of processes, which combines multimodal emotion estimation and dynamic expression control by AI, differs from conventional static analysis result display or manual human judgment, and brings about technical effects such as improvement in user experience, optimization of information transmission efficiency, and enhancement of overall system flexibility. Application fields include personalized gift recommendation, mental health care support, user experience optimization applications, educational support systems, etc. For AI model training, advanced methods such as supervised learning using emotion-labeled talk history datasets, multimodal integrated learning, and data augmentation (e.g., synthesis of emotion patterns) can be combined. As a result, the analysis unit flexibly adapts to different emotion patterns and information reception characteristics for each user, achieving highly accurate and efficient analysis result presentation that surpasses conventional technology.

The selection unit can analyze the other party's past present histories when selecting a present and select an optimal present. For example, the selection unit may select an optimal present based on presents the other party has received in the past. Additionally, the selection unit can select similar presents based on presents that the other party has enjoyed in the past. Furthermore, the selection unit can analyze trends in the presents received by the other party and select an optimal present accordingly. Thus, by analyzing past present histories, the selection unit can select an optimal present. Specifically, the selection unit receives as input the other party's past present history data (e.g., structured data including present ID, category, date of presentation, satisfaction rating, comment feedback, etc.). The selection unit first performs normalization of history data (e.g., category unification, date format conversion), morphological analysis and sentiment analysis of text data (e.g., positive/negative judgment from comment feedback) in a preprocessing unit. Next, using an AI model for history analysis (e.g., Transformer-based history pattern extraction model, gradient boosting decision tree, etc.), trends in past presents (e.g., category distribution, price range, frequency of presentation, time-series changes in satisfaction scores, etc.) are extracted as multidimensional feature vectors. Examples of input data for the AI model include “5 books, 2 gadgets, 1 trip in the past 3 years,” “Satisfaction scores: books 0.9, gadgets 0.7, trips 1.0,” etc. Examples of AI model output include “Optimal category: travel, recommendation score 0.95,” “Similar present candidates: books (score 0.88), gadgets (score 0.81),” etc. The selection unit matches these analysis results with a present candidate database and preferentially extracts new presents with categories or attributes that received high ratings in the past. Furthermore, time-series changes in history, seasonality, and event relevance are also considered, and patterns such as “books last year, travel this year” are automatically learned. As a subsequent process, the selected present candidates are generated as a ranking list and proposed to the user. This series of processes, which combines high-dimensional history pattern analysis and dynamic recommendation by AI, differs from conventional simple history referencing or human heuristics, and brings about technical effects such as significant improvement in proposal accuracy, user satisfaction, and system operational efficiency. Application fields include gift EC sites, employee benefit systems, event promotion, personalized advertising, etc. For AI model training, advanced methods such as supervised learning using history-labeled datasets, history content clustering, and data augmentation (e.g., synthesis of history patterns) can be combined. As a result, the selection unit flexibly adapts to different history patterns and preference trends for each recipient, achieving highly accurate and efficient present selection that surpasses conventional technology.

The providing unit can estimate a user's emotion and adjust the operation procedure of present proposals based on the estimated emotion. For example, if the user is nervous, the operation procedure is simplified to allow intuitive operation. Additionally, if the user is relaxed, the providing unit can offer detailed operation procedures and propose customizable options. Furthermore, if the user is in a hurry, the providing unit can offer voice input or shortcuts to enable rapid operation. Thus, by adjusting the operation procedure based on the user's emotion, the providing unit can provide more appropriate present proposals. Specifically, the providing unit receives various input data for user emotion estimation, such as text data of talk histories (e.g., UTF-8 encoded utterance sequences, time-stamped utterance logs), audio data (e.g., WAV format audio waveforms, spectrogram images), and image data (e.g., facial expression images, sticker images). The providing unit first performs noise removal, normalization, and feature extraction (e.g., MFCC feature extraction from audio, facial expression feature extraction from images) in a preprocessing unit. Next, using an AI model for emotion estimation (e.g., BERT-based emotion classifier, ResNet-based facial expression recognition CNN, RNN for speech emotion recognition, etc.), the input data is converted into multidimensional feature vectors (e.g., text 768 dimensions, audio 128 dimensions, image 512 dimensions), and emotion labels (e.g., nervousness, relaxation, hurry, etc.) and emotion scores (e.g., probability values for each emotion, e.g., nervousness 0.73, relaxation 0.21, hurry 0.06) are output. Examples of input data include utterances such as “I'm nervous,” “I can relax today,” “I'm in a hurry,” as well as images of nervous facial expressions and audio data of calm voices. Examples of AI model output include “Emotion label: nervousness, score 0.81,” “Emotion label: relaxation, score 0.92,” “Emotion label: hurry, score 0.88,” etc. Based on these emotion estimation results, the operation procedure control module, for example, automatically adjusts the operation procedure using rule-based or AI optimization algorithms, such as “minimize operation steps and generate a one-tap completion UI when nervous,” “display detailed customization options and help guides when relaxed,” “enable voice input and shortcut buttons for rapid operation when in a hurry.” As a subsequent process, the adjusted operation procedure is sent to the user interface, and an operation experience optimized for the user's emotional state is realized. This series of processes, which combines multimodal emotion estimation and dynamic UI control by AI, differs from conventional static operation flows or manual human judgment, and brings about technical effects such as improvement in user experience, optimization of operation efficiency, and enhancement of overall system flexibility. Application fields include personalized gift recommendation, user experience optimization applications, educational support systems, accessibility support, etc. For AI model training, advanced methods such as supervised learning using emotion-labeled talk history datasets, multimodal integrated learning, and data augmentation (e.g., synthesis of emotion patterns) can be combined. As a result, the providing unit flexibly adapts to different emotion patterns and operation characteristics for each user, achieving highly accurate and efficient present proposal operation that surpasses conventional technology.

The following provides a brief explanation of the processing flow of Example of the Embodiment. Specifically, the present system operates in cooperation among modules including a collection unit, an analysis unit, a selection unit, and a providing unit, to analyze and optimize user talk history data using various AI models, thereby realizing personalized gift recommendations and information presentation. First, the collection unit automatically collects talk histories such as text, voice, and images from multiple communication applications and devices used by the user. The collection unit attaches multidimensional metadata to each history, including category, importance, relevance, submission timing, emotional state, location information, and social media activities, and performs dynamic filtering and prioritization using AI. Next, the analysis unit performs multimodal analysis by combining natural language processing models (e.g., Transformer-based text analyzers), image recognition models (e.g., CNN), and voice analysis models (e.g., RNN) on the collected history data, and conducts multi-stage analysis such as category classification, importance estimation, emotion estimation, topic extraction, and event relevance estimation. The analysis unit dynamically adjusts the level of detail and expression method of the analysis based on the outputs of the AI models (e.g., category labels, importance scores, emotion scores, relevance scores), and generates analysis results optimized for the user's situation and requirements. Furthermore, the selection unit inputs diverse features such as analysis results, user and other party's histories, emotions, events, location, and social activities, and generates a ranking of optimal present candidates using AI models (e.g., history pattern extraction models, recommendation models). The selection unit automatically adjusts the selection process and priority according to emotions and situations, thereby realizing personalized recommendations. Finally, the providing unit considers the user's emotion, device, history, and operation characteristics, and automatically generates optimal display methods and operation procedures using AI models (e.g., UI optimization models), presenting information to the user interface. This series of processes, unlike conventional static rule-based or manual human judgment, combines AI-based multimodal analysis, dynamic control, and optimization, resulting in technical effects such as improved user experience, optimized information transmission efficiency, and enhanced flexibility, scalability, and accuracy of the entire system. Application fields include gift e-commerce sites, welfare systems, event promotion, personalized advertising, educational support, mental healthcare, IoT-linked services, and the like.

Step 1: The collection unit collects talk histories. The talk histories include text messages, voice messages, images, and the like. The collection unit acquires talk histories from communication applications used by the user. Step 2: The analysis unit analyzes the talk histories collected by the collection unit. The analysis unit analyzes the talk histories using natural language processing technology, performing morphological analysis, grammatical analysis, semantic analysis, and so on. The analysis unit identifies the preferences and interests of the other party from the talk histories, extracts keywords contained in the talk histories, and identifies information about hobbies and desired items that the other party frequently discusses. Step 3: The selection unit selects a present based on the analysis result obtained by the analysis unit. The selection unit selects presents such as goods, services, and digital content based on the preferences and interests of the other party. The processing in the selection unit may be performed using AI, and the selection unit can select a present using an AI model that inputs the analysis result and outputs a present. Specifically, in Step 1, the present system has the collection unit automatically collect talk history data (e.g., text arrays, audio files, image data, metadata such as sender, receiver, timestamp, etc.) from multiple communication applications and devices used by the user. The collection unit attaches multidimensional metadata to each history, such as category (e.g., hobbies, events, daily conversations, etc.), importance, relevance, submission timing, emotional state, location information, social media activities, and performs dynamic filtering and prioritization using AI models (e.g., history pattern extraction models, importance estimation models, etc.). In Step 2, the analysis unit performs multimodal analysis by combining natural language processing models (e.g., Transformer-based text analyzers), image recognition models (e.g., CNN), and voice analysis models (e.g., RNN) on the collected history data, and conducts multi-stage analysis such as category classification, importance estimation, emotion estimation, topic extraction, and event relevance estimation. The analysis unit dynamically adjusts the level of detail and expression method of the analysis based on the outputs of the AI models (e.g., category labels, importance scores, emotion scores, relevance scores), and generates analysis results optimized for the user's situation and requirements. In Step 3, the selection unit inputs diverse features such as analysis results, user and other party's histories, emotions, events, location, and social activities, and generates a ranking of optimal present candidates using AI models (e.g., history pattern extraction models, recommendation models). The selection unit automatically adjusts the selection process and priority according to emotions and situations, thereby realizing personalized recommendations. This series of processes, unlike conventional static rule-based or manual human judgment, combines AI-based multimodal analysis, dynamic control, and optimization, resulting in technical effects such as improved user experience, optimized information transmission efficiency, and enhanced flexibility, scalability, and accuracy of the entire system. Application fields include gift e-commerce sites, welfare systems, event promotion, personalized advertising, educational support, mental healthcare, IoT-linked services, and the like.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, analysis unit, selection unit, and providing unit is implemented by at least one of, for example, a smart device 14 and a data processing apparatus 12. For example, the collection unit is implemented by a control unit 46A of the smart device 14 and acquires talk histories from a communication application. The analysis unit is implemented, for example, by a specific processing unit 290 of the data processing apparatus 12 and analyzes the talk histories using natural language processing technology. The selection unit is implemented, for example, by the specific processing unit 290 of the data processing apparatus 12 and selects a present based on the analysis result. The providing unit is implemented, for example, by the control unit 46A of the smart device 14 and provides detailed information of the proposed present to the user. The correspondence between each unit and the apparatus or control unit is not limited to the examples described above and various modifications are possible.

### Second Embodiment

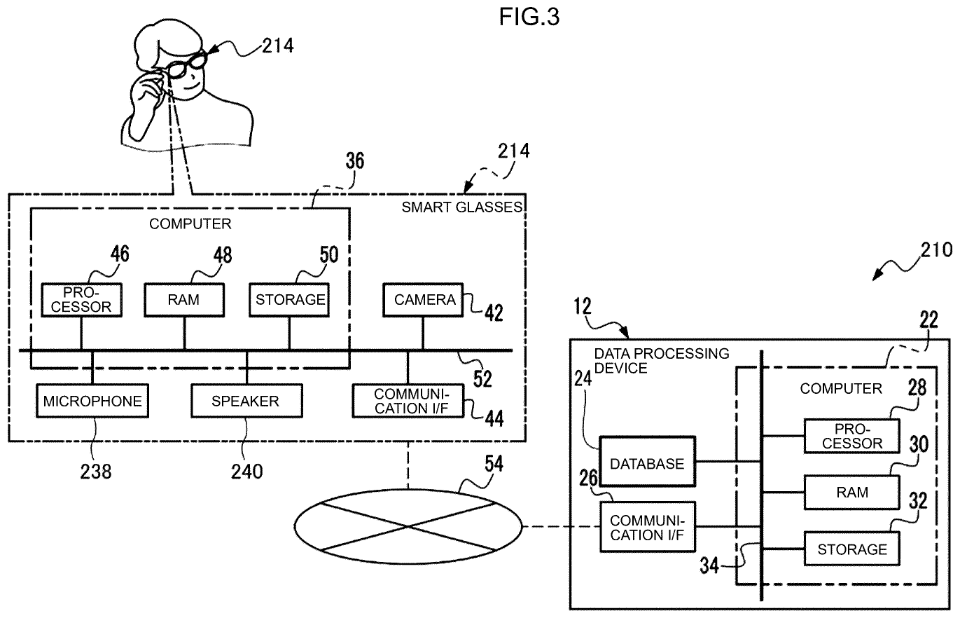

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

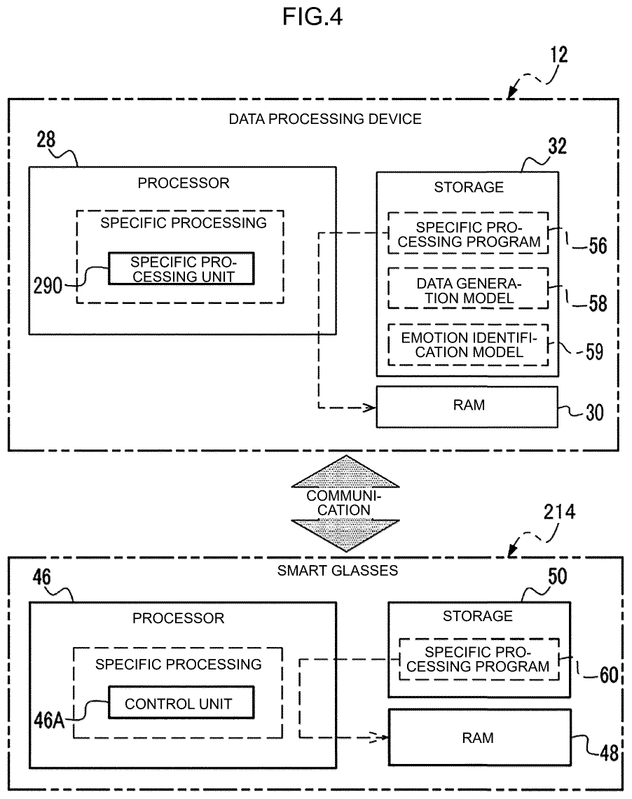

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, analysis unit, selection unit, and providing unit is implemented by at least one of, for example, smart glasses 214 and a data processing apparatus 12. For example, the collection unit is implemented by a control unit 46A of the smart glasses 214 and acquires talk histories from a communication application. The analysis unit is implemented, for example, by a specific processing unit 290 of the data processing apparatus 12 and analyzes the talk histories using natural language processing technology. The selection unit is implemented, for example, by the specific processing unit 290 of the data processing apparatus 12 and selects a present based on the analysis result. The providing unit is implemented, for example, by the control unit 46A of the smart glasses 214 and provides detailed information of the proposed present to the user. The correspondence between each unit and the apparatus or control unit is not limited to the examples described above and various modifications are possible.

### Third Embodiment

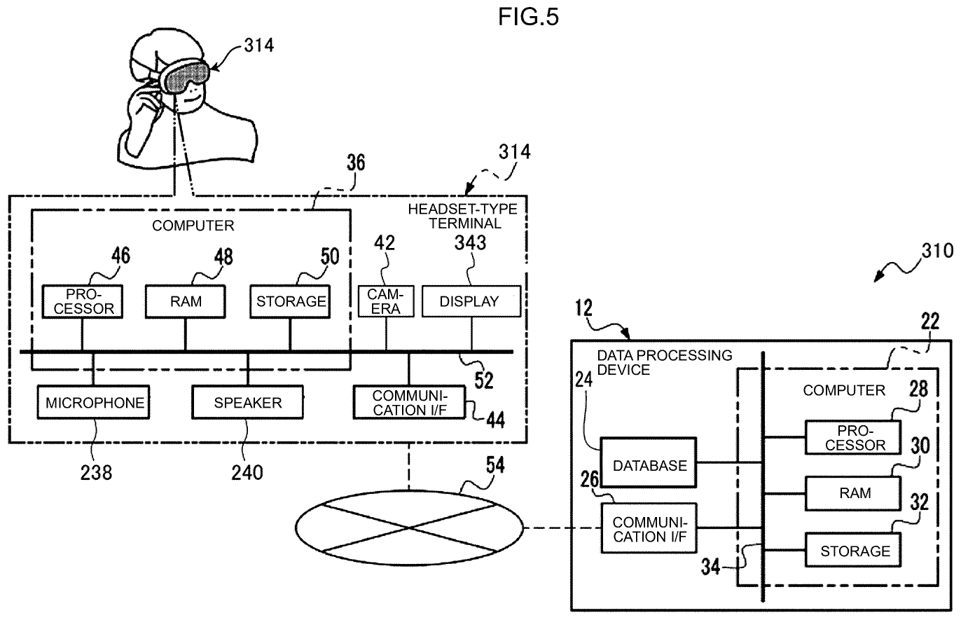

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

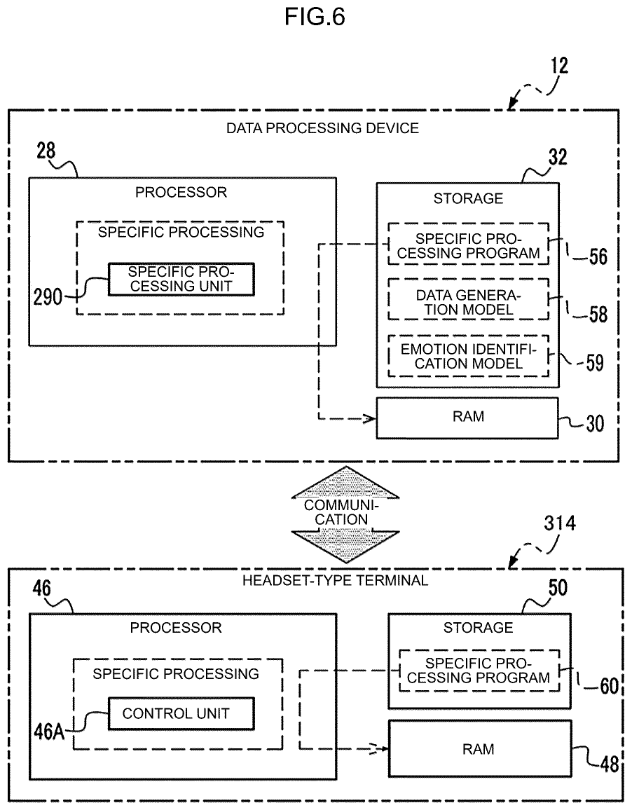

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, analysis unit, selection unit, and providing unit is implemented by at least one of, for example, a headset-type terminal 314 and a data processing apparatus 12. For example, the collection unit is implemented by a control unit 46A of the headset-type terminal 314 and acquires talk histories from a communication application. The analysis unit is implemented, for example, by a specific processing unit 290 of the data processing apparatus 12 and analyzes the talk histories using natural language processing technology. The selection unit is implemented, for example, by the specific processing unit 290 of the data processing apparatus 12 and selects a present based on the analysis result. The providing unit is implemented, for example, by the control unit 46A of the headset-type terminal 314 and provides detailed information of the proposed present to the user. The correspondence between each unit and the apparatus or control unit is not limited to the examples described above and various modifications are possible.

### Fourth Embodiment

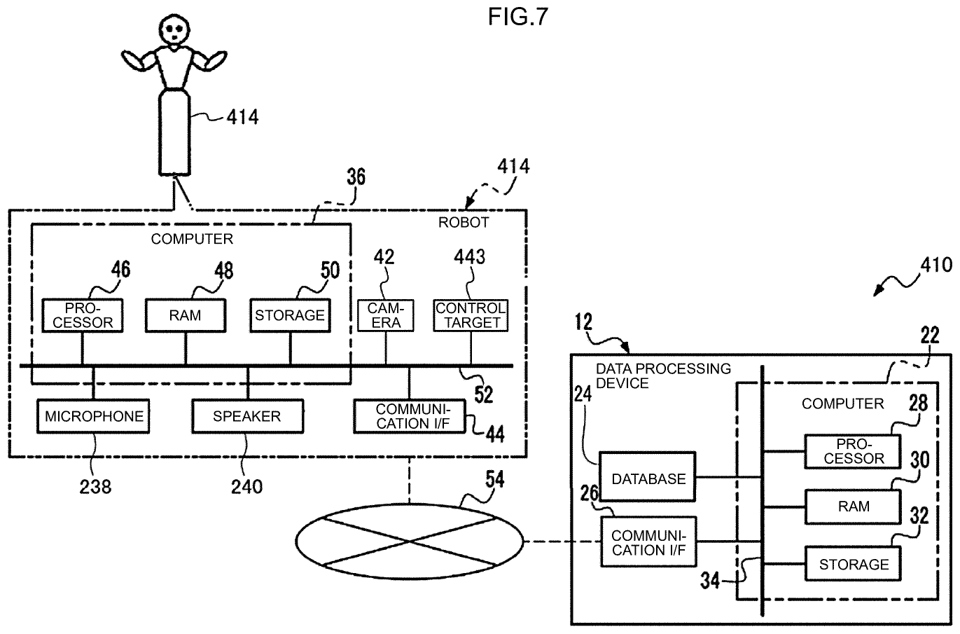

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

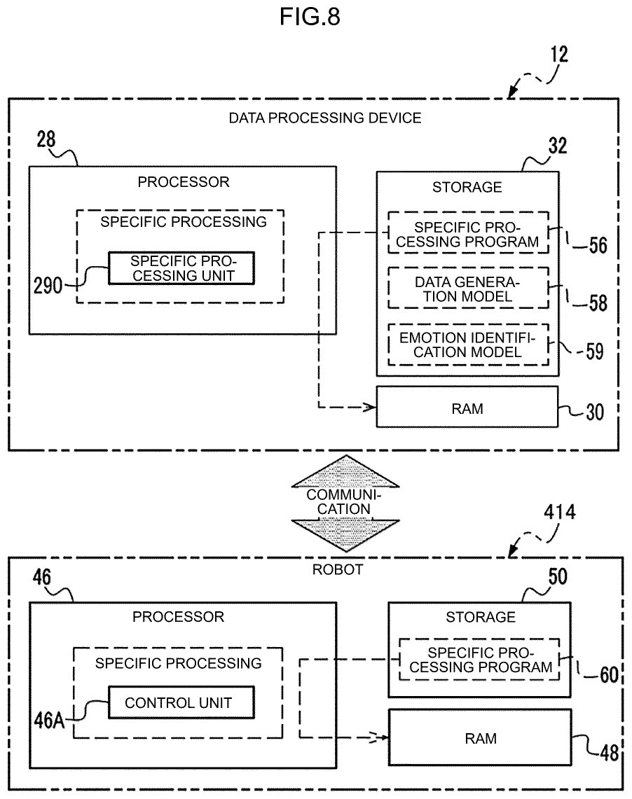

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, analysis unit, selection unit, and providing unit is implemented by at least one of, for example, a robot 414 and a data processing apparatus 12. For example, the collection unit is implemented by a control unit 46A of the robot 414 and acquires talk histories from a communication application. The analysis unit is implemented, for example, by a specific processing unit 290 of the data processing apparatus 12 and analyzes the talk histories using natural language processing technology. The selection unit is implemented, for example, by the specific processing unit 290 of the data processing apparatus 12 and selects a present based on the analysis result. The providing unit is implemented, for example, by the control unit 46A of the robot 414 and provides detailed information of the proposed present to the user. The correspondence between each unit and the apparatus or control unit is not limited to the examples described above and various modifications are possible.

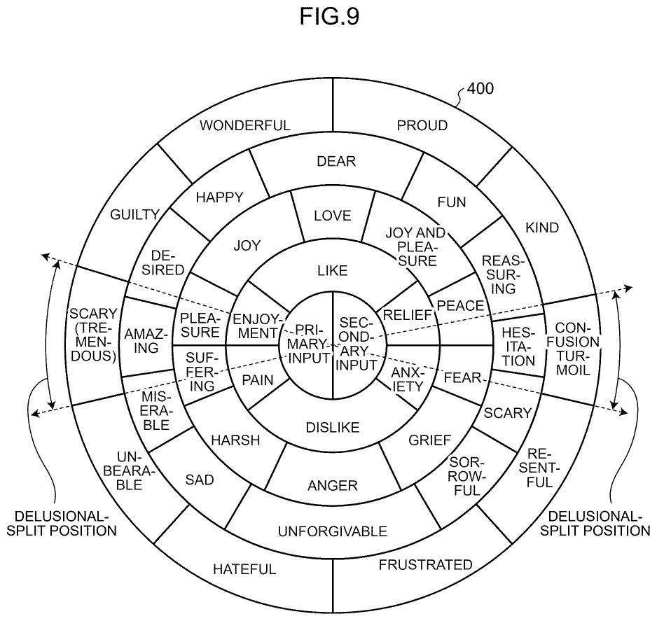

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

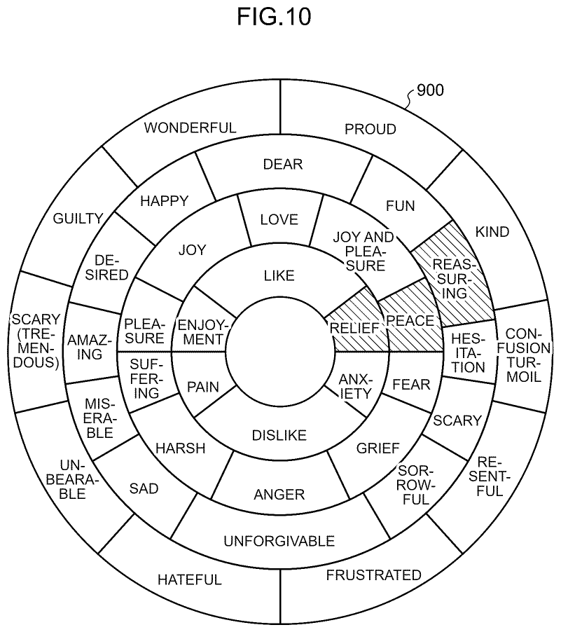

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect talk histories; an analysis unit configured to analyze the collected talk histories; and a selection unit configured to select a present based on an analysis result obtained by the analysis unit.
(Supplementary Note 2)The system according to Supplementary Note 1, wherein the analysis unit is configured to analyze the talk histories using natural language processing technology.
(Supplementary Note 3)The system according to Supplementary Note 1, wherein the selection unit is configured to select a specific present.
(Supplementary Note 4)The system according to Supplementary Note 1, wherein the selection unit is configured to select a present based on the preferences or interests of the other party.
(Supplementary Note 5)The system according to Supplementary Note 1, further comprising a unit configured to provide a result of present proposals to a user.
(Supplementary Note 6)The system according to Supplementary Note 1, wherein the collection unit is configured to estimate a user's emotion and adjust the timing of collecting talk histories based on the estimated emotion.
(Supplementary Note 7)The system according to Supplementary Note 1, wherein the collection unit is configured to analyze a user's past talk histories and select an appropriate collection method.
(Supplementary Note 8)The system according to Supplementary Note 1, wherein the collection unit is configured to perform filtering based on a user's current interests or events when collecting talk histories.
(Supplementary Note 9)The system according to Supplementary Note 1, wherein the collection unit is configured to estimate a user's emotion and determine the priority of talk histories to be collected based on the estimated emotion.
(Supplementary Note 10)The system according to Supplementary Note 1, wherein the collection unit is configured to preferentially collect highly relevant talk histories based on the user's geographic location information when collecting talk histories.
(Supplementary Note 11)The system according to Supplementary Note 1, wherein the collection unit is configured to analyze a user's social media activities and collect relevant talk histories when collecting talk histories.
(Supplementary Note 12)The system according to Supplementary Note 1, wherein the analysis unit is configured to estimate a user's emotion and adjust the expression method of analysis based on the estimated user's emotion.
(Supplementary Note 13)The system according to Supplementary Note 1, wherein the analysis unit is configured to adjust the level of detail of analysis based on the importance of the talk histories during analysis.
(Supplementary Note 14)The system according to Supplementary Note 1, wherein the analysis unit is configured to apply different analysis algorithms according to the category of the talk histories during analysis.
(Supplementary Note 15)The system according to Supplementary Note 1, wherein the analysis unit is configured to estimate a user's emotion and adjust the length of analysis based on the estimated user's emotion.
(Supplementary Note 16)The system according to Supplementary Note 1, wherein the analysis unit is configured to determine the priority of analysis based on the submission timing of the talk histories during analysis.
(Supplementary Note 17)The system according to Supplementary Note 1, wherein the analysis unit is configured to adjust the order of analysis based on the relevance of the talk histories during analysis.
(Supplementary Note 18)The system according to Supplementary Note 1, wherein the selection unit is configured to estimate a user's emotion and adjust the method of selecting a present based on the estimated user's emotion.
(Supplementary Note 19)The system according to Supplementary Note 1, wherein the selection unit is configured to analyze the other party's past present histories and select an optimal present when selecting a present.
(Supplementary Note 20)The system according to Supplementary Note 1, wherein the selection unit is configured to customize a present based on the other party's current living situation or events when selecting a present.
(Supplementary Note 21)The system according to Supplementary Note 1, wherein the selection unit is configured to estimate a user's emotion and determine the priority of presents based on the estimated user's emotion.
(Supplementary Note 22)The system according to Supplementary Note 1, wherein the selection unit is configured to select an optimal present by considering the other party's geographic location information when selecting a present.
(Supplementary Note 23)The system according to Supplementary Note 1, wherein the selection unit is configured to analyze the other party's social media activities and select a present when selecting a present.
(Supplementary Note 24)The system according to Supplementary Note 1, wherein the providing unit is configured to estimate a user's emotion and adjust the display method of present proposals based on the estimated user's emotion.
(Supplementary Note 25)The system according to Supplementary Note 1, wherein the providing unit is configured to refer to the user's past proposal histories and select an optimal display method when proposing a present.
(Supplementary Note 26)The system according to Supplementary Note 1, wherein the providing unit is configured to estimate a user's emotion and adjust the operation procedure of present proposals based on the estimated user's emotion.
(Supplementary Note 27)The system according to Supplementary Note 1, wherein the providing unit is configured to consider the user's device information and select an optimal display method when proposing a present.

What is claimed is:

1. A system comprising:
circuitry configured to:
acquire communication data from a communication application, the communication data comprising at least one of text data, audio data, or image data;
generate a feature vector by applying a natural language processing model to the communication data, the natural language processing model comprising a Transformer-based encoder configured to generate a semantic vector representing contextual meaning of the communication data;
extract preference information from the feature vector by performing at least one of keyword extraction, topic clustering, or sentiment analysis; and
generate recommendation data based on the extracted preference information by inputting the feature vector to a trained classification model.

2. The system according to claim 1, wherein the recommendation data comprises a selection of a present for a recipient based on preferences or interests of the recipient identified from the communication data.

3. The system according to claim 1, wherein the circuitry is further configured to provide the recommendation data to a user via a user interface, the recommendation data comprising at least one of a name, a price, a purchase source, or a recommendation reason for each recommended item.

4. The system according to claim 1, wherein the circuitry is further configured to estimate an emotion of a user and adjust timing of acquiring the communication data based on the estimated emotion.

5. The system according to claim 1, wherein the circuitry is further configured to analyze past communication data of a user and select a collection method for acquiring the communication data based on the analysis.

6. The system according to claim 1, wherein the circuitry is further configured to filter the communication data based on current interests or events of a user when acquiring the communication data.

7. The system according to claim 1, wherein the circuitry is further configured to estimate an emotion of a user and determine a priority of communication data to be acquired based on the estimated emotion.

8. The system according to claim 1, wherein the circuitry is further configured to preferentially acquire communication data based on geographic location information of a user.

9. The system according to claim 1, wherein the circuitry is further configured to analyze social media activity of a user and acquire communication data relevant to the social media activity.

10. The system according to claim 1, wherein the circuitry is further configured to estimate an emotion of a user and adjust an expression method of analysis results based on the estimated emotion.

11. The system according to claim 1, wherein the circuitry is further configured to adjust a level of detail of analysis based on importance of the communication data.

12. The system according to claim 1, wherein the circuitry is further configured to apply different analysis algorithms according to a category of the communication data, the category comprising at least one of a hobby category, a desired item category, or an event category.

13. The system according to claim 1, wherein the circuitry is further configured to estimate an emotion of a user and adjust a length of analysis output based on the estimated emotion.

14. The system according to claim 1, wherein the circuitry is further configured to determine a priority of analysis based on submission timing of the communication data.

15. The system according to claim 1, wherein the natural language processing model comprises at least one of a morphological analyzer, a grammatical parser, or a semantic analyzer.

16. The system according to claim 1, wherein the trained classification model comprises at least one of a gradient boosting decision tree or a multilayer perceptron.

17. The system according to claim 1, wherein the circuitry is further configured to convert audio data to text data using a speech recognition engine and extract image features from image data using a convolutional neural network prior to generating the feature vector.

18. A system comprising:
a communication interface configured to communicate with a client terminal via a network;
a processor;
a random-access memory;
a memory storing a natural language processing model and a classification model; and
circuitry configured to:
receive, via the communication interface, communication data from the client terminal, the communication data comprising at least one of text data exported from a communication application, audio data of voice messages, or image data;
preprocess the communication data by normalizing text data, converting audio data to text via speech recognition, and extracting image features using a convolutional neural network;
generate a feature vector by applying the natural language processing model to the preprocessed communication data, the natural language processing model comprising a Transformer-based encoder configured to generate a semantic vector;
extract preference information by performing keyword extraction using TF-IDF scoring, topic clustering using K-means clustering, and sentiment analysis using a multi-class emotion classifier;
generate recommendation data by inputting the feature vector to the classification model, the classification model outputting scores for a plurality of recommendation candidates; and
transmit, via the communication interface, the recommendation data to the client terminal for display on a user interface.

19. The system according to claim 18, wherein the recommendation data comprises a ranked list of present candidates with associated scores and recommendation reasons based on preferences identified from the communication data.

20. A method performed by circuitry of a system, the method comprising:
acquiring communication data from a communication application, the communication data comprising at least one of text data, audio data, or image data;
generating a feature vector by applying a natural language processing model to the communication data, the natural language processing model comprising a Transformer-based encoder configured to generate a semantic vector representing contextual meaning of the communication data;
extracting preference information from the feature vector by performing at least one of keyword extraction, topic clustering, or sentiment analysis; and
generating recommendation data based on the extracted preference information by inputting the feature vector to a trained classification model.
